(19) United States
(12) Patent Application Publication
(10) Pub. No.: US 2009/0287559 A1
(43) Pub. Date: Nov. 19, 2009

(54) TabTab

(76) Inventors: Michael Chen, Scarsdale, NY (US); David Hom, New York, NY (US); Ounehenne Pnakonsonh, Irvine, CA (US)

Correspondence Address: Allan Chan, Suite 700, 225 Broadway, New York, NY, 10007, US

(21) Appl. No.: 12/322,510

(22) Filed: Feb. 2, 2009

Related U.S. Application Data
(63) Continuation-in-part of application No. 12/004,652, filed on Dec. 20, 2007.

(51) Int. Cl. G06Q 30/00; G06F 3/01; G06F 3/048

(52) U.S. Cl. 705/14.23; 705/14.51; 705/27; 705/34; 715/744; 715/777

(57) ABSTRACT

Electronic advertisements and other types of electronic information are distributed based on user profiles and in particular, collections of widgets. User profiles may be generated based on a combination of user searches for specific items or points of interest. Alternatively user interests may be determined by the customized tabs setup by said user for his own personal web portal. User entered information and information inferred or derived from user behavior and interaction patterns may be used to determine the type of directed advertisement to be targeted to a specific user. The use and collection of various widgets may also be recorded by a user profile to determine a user's preferences and interests. An advertisement may be distributed by segmenting a user population according to user profile information and one or more attributes of the advertisement. Users may further interact with the widgets in a variety of ways including specifying product request details such as make, model, price and color, requesting additional information about the advertised product or service and/or requesting communications with an advertiser without compromising their privacy. Thus, unnecessary surfing of the internet may be eliminated for updated information and internet commerce.

### CROSS REFERENCE TO RELATED APPLICATIONS

This application is a continuation in part of U.S. patent application Ser. No, 12/004,652 entitled “Bar Tab”—the entireties of these applications are incorporated herein by reference.

### BACKGROUND OF THE INVENTION

### Field of the Invention

The present invention is directed to computer interfaces and, more particularly, to a method and system of providing customizable toolbars to efficiently and effectively access the internet.

### SUMMARY OF THE INVENTION

TabTab is a new multi-tab toolbar that allows you to create an innovative, customized, shareable toolbar. Our one of a kind platform offers you the ability to add multiple toolbars in a tabbed format, organize and aggregate information into a tablet, add any website, link, or widgets, and fully customize search preferences to display multiple search engine results on one page. Tab Tab incorporates all the relevant web technologies such as music, videos, photos, feeds, widgets, start-pages, social networking, and search, which are all essential for today's web user. Our toolbar will allow for you to discover hundreds of vertical niche toolbars, tablets, widgets that can be easily added and shared with the TabTab community. Unlike traditional toolbars, you can access your toolbar from any computer with an internet connection.

Many problems are solved by providing a method and system that enhances segmentation of a user population for advertising and other information distribution purposes. To that end, a user profile may be generated for each user tab portal setup for each user in the internet user population to track and record user behavior and record the types of tab widgets or website segments a user collects on his or her tab portal. A user profile may further record how frequently a user interacts with a particular type of advertisement or advertisement widget. The user profile information may then be used by a server to segment the user population in accordance with one or more target parameters of a particular advertisement. Thus, advertisements may be distributed based not only on user defined information, but also on information learned from user interaction and use patterns and preferences. Information gathered as a result of user customization of his or her tab web portal will be utilized to assist in the methodology of directed advertisements.

An embodiment of the invention includes providing one or more customizable toolbars, which may be associated with a Internet browser or an act as an independent window. The method can comprise directing an Internet browser user, using a computer, to a button modification medium, receiving modification information from the Internet browser user and loading the modified buttons onto a tab portal toolbar on the computer. In certain embodiments, information related to the customizable toolbars is stored at a remote server such that a user may implement and/or modify certain parameters regarding the customizable buttons on a user interface computer, and then have access to the buttons while using any other computer. The current invention aims to be the one central place where users can do everything such as but not limited to search, email, chat, watch videos, view photos, listen to music or podcast.

Tab portal toolbar aims to be the one central place where users can do everything from search, email, chat, watch videos, view photos, listen to music or podcast, and more.

Users can create customized and personalized different toolbars for their specific interests eliminating the need to cram all buttons onto one tab portal toolbar.

Users can create Tablets on the tab portal toolbar which launches multiple applications in a Tablet Window. This Tablet Window can serve as a startup page, a collection of modules, or information for a particular interest. With the Ajax features it will make it easy for users to organize and personalize their toolbars and tablets.

Users can browse other user's tab portal toolbar and tablets in the community and replicate their tab portal toolbar and tablet if they find it useful. Users can add on and improve on existing toolbars and tablets making it even more useful and contain more content for everyone in the community. Users can share and improve on tab portal toolbar—adding more functions and content for users.

Users can share and improve on tablet—adding more functions and content for users. Users can create specific tab portal toolbar that they can use and share only with people they choose.

Tab portal toolbar will eventually be a central place where users can do anything online, just from a tab portal toolbar. Tab portal toolbar will make it easy for users to share and send useful content to other users.

A tab portal toolbar community will be built where users can not only network with each other but contribute back to their community by sharing their content—news, photos, videos, bookmarks, feeds, toolbars and tablets which others might find useful and can pass along to their friends. Users can discover new sites from other user's bookmarks. Users can receive instant alerts/deals on their tab portal toolbar.

Unlike other social networking sites, where you really can't give to others except maybe a compliment, Tab portal toolbar allows users in the community to actually share toolbars and tablets that they personally created. Users would also be able to easily share any of their digital content with other users.

The current invention is created to provide a platform where users, tabbers can easily send each other messages, videos, photos, games, bookmarks of sites they find interesting, and whatever they would like to share. Our tab portal toolbar community aims to provide tabbers with a central place that they can share, give and help each other in making their online experience a more productive, efficient, and fulfilling one.

The preferred embodiment, users may also utilize the Tab portal toolbar to continuously monitor elements on the web desired by the user. For example, the user may be interested in a certain product online to purchase or just of interest. Parameters of Tab portal toolbar can be customized to monitor the particular item at selected stores or in general on the web. Users may set a particular price point or price range to be notified by Tab portal toolbar. Users may also desire to monitor availability of an item which has been sold out or not yet released. Notification may include but not limited to text messages, phone call, emails, popup notification or fax.

Other objects and features of the present invention will become apparent from the following detailed description, considered in conjunction with the accompanying drawing figures. It is understood, however, that the drawings are designed solely for the purpose of illustration and not as a definition of the limits of the invention, for which reference should be made to the appended claims.

1. The layout of our toolbar especially the multiple tabs feature, which allow users to add & browse between different toolbars.
2. Providing alerts to users via our toolbar especially our web clip feature which allows user to clip a section of a webpage and then we'll be able to send them an alert when there's an update.
3. Our business model which is to allow users to set certain criteria in a widget and alert them when there are results that fixes those criteria.

### BRIEF DESCRIPTION OF THE DRAWING FIGURES

FIG. 1 shows one embodiment illustrating the system environment involving an internet search with results displayed in multiple windows within the tab tab system environment window.

FIG. 2 shows one embodiment of ecommerce results toolbar with multiple windows displaying varied results including merchant widgets.

FIG. 3 shows one embodiment of the tab tab toolbar.

FIG. 4 shows one embodiment of widget business flowchart.

FIG. 5 shows one embodiment of user's sponsor widget flowchart.

FIG. 6 shows one embodiment of tab tab system server configuration.

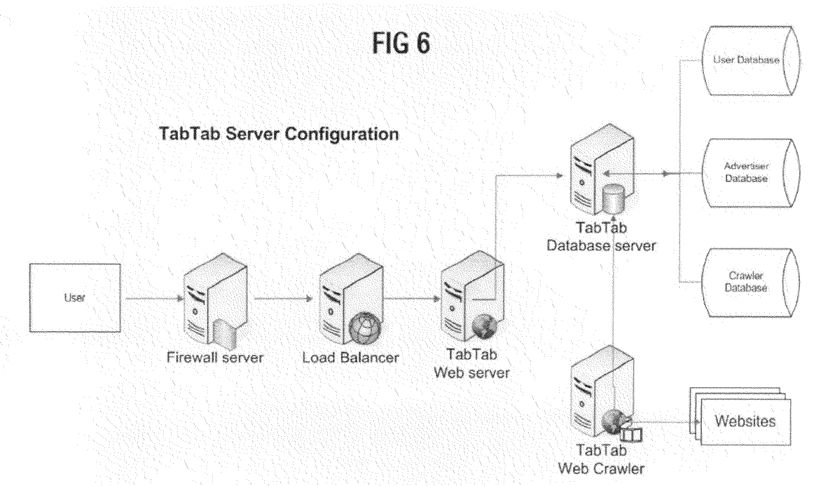

FIG. 7 shows one embodiment of a menu to invite friends.

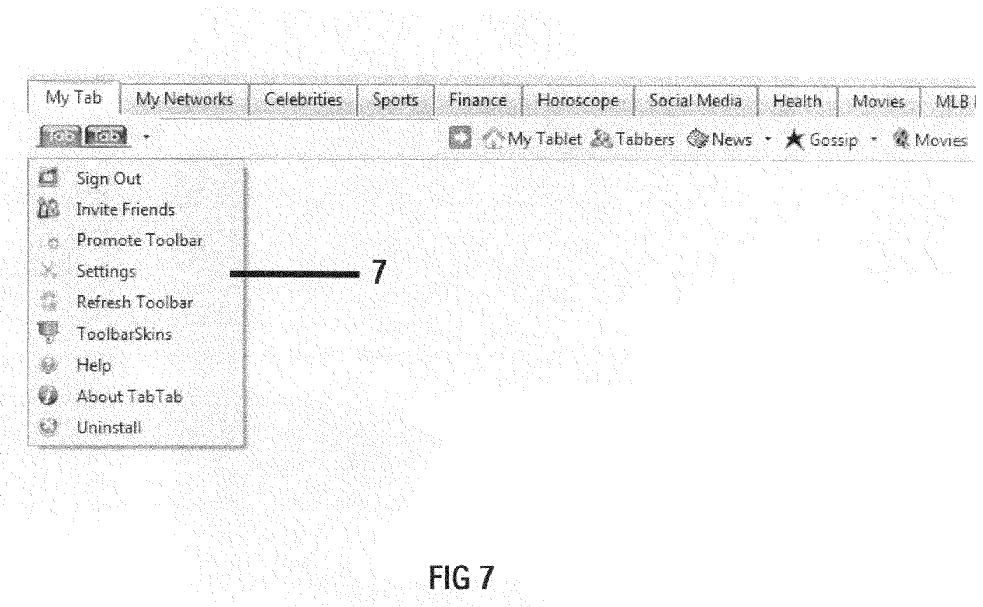

FIG. 8 shows one embodiment of page to invite friends.

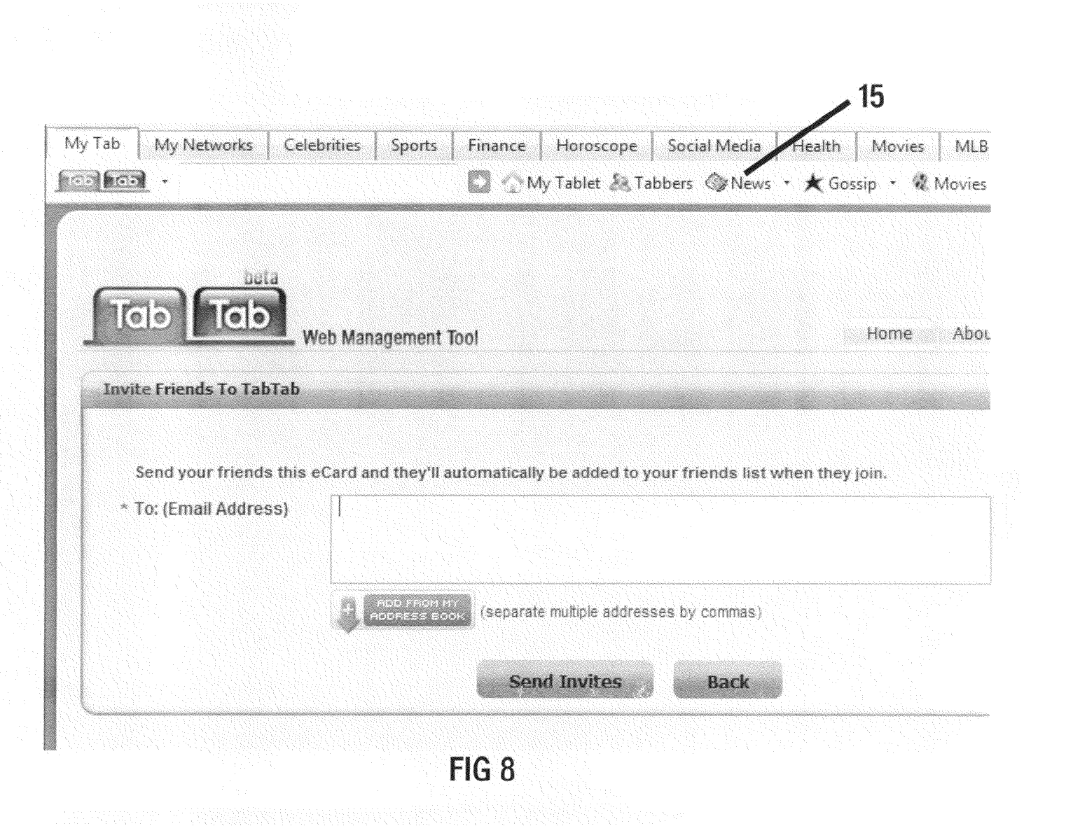

FIG. 9 shows one embodiment of sharing a tab with other users.

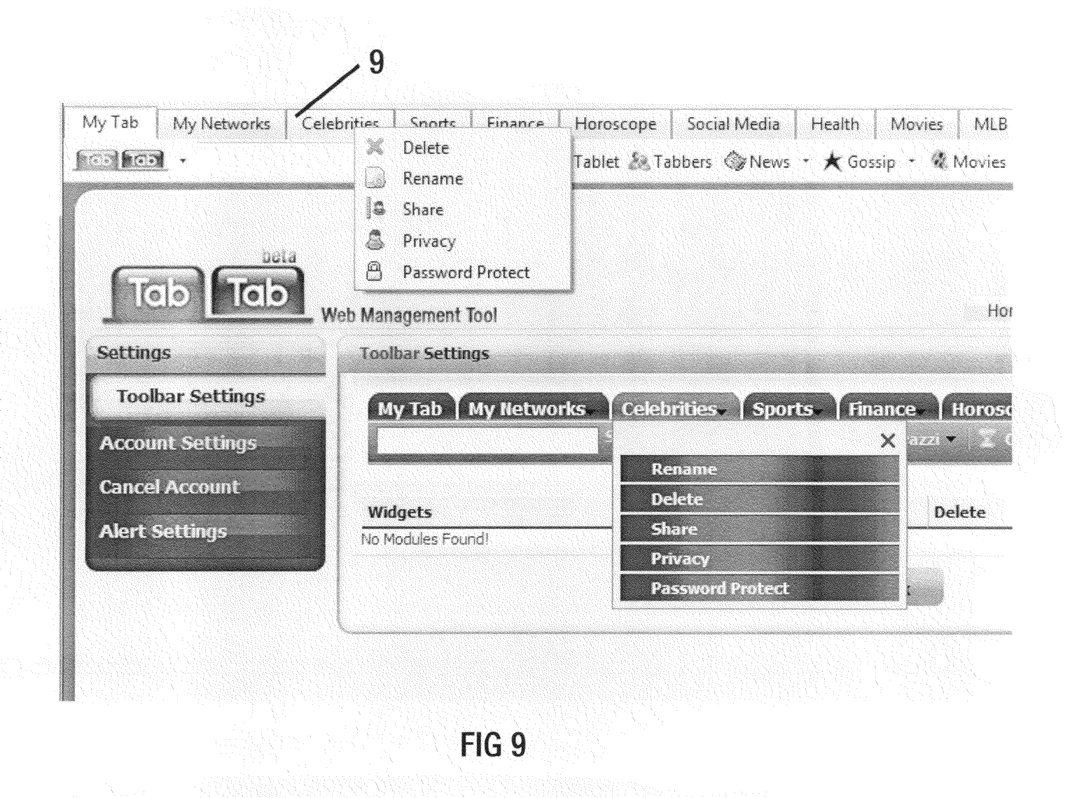

FIG. 10 shows one embodiment of share tab page with other users.

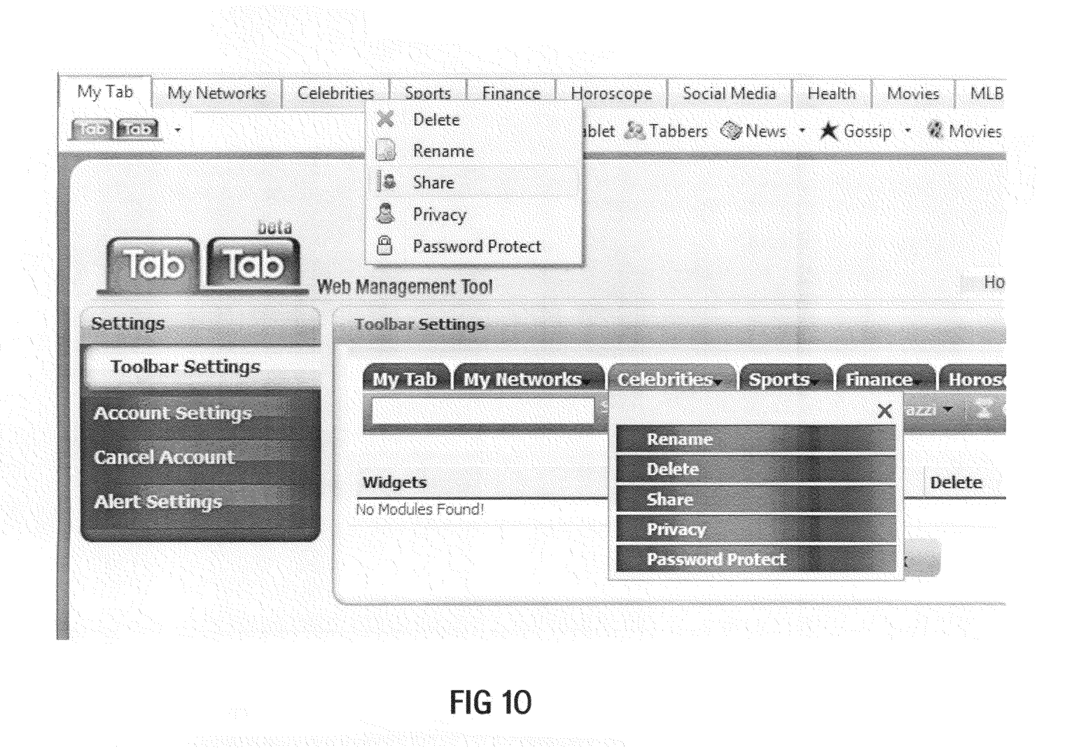

FIG. 11 shows one embodiment of sharing a tablet with other users.

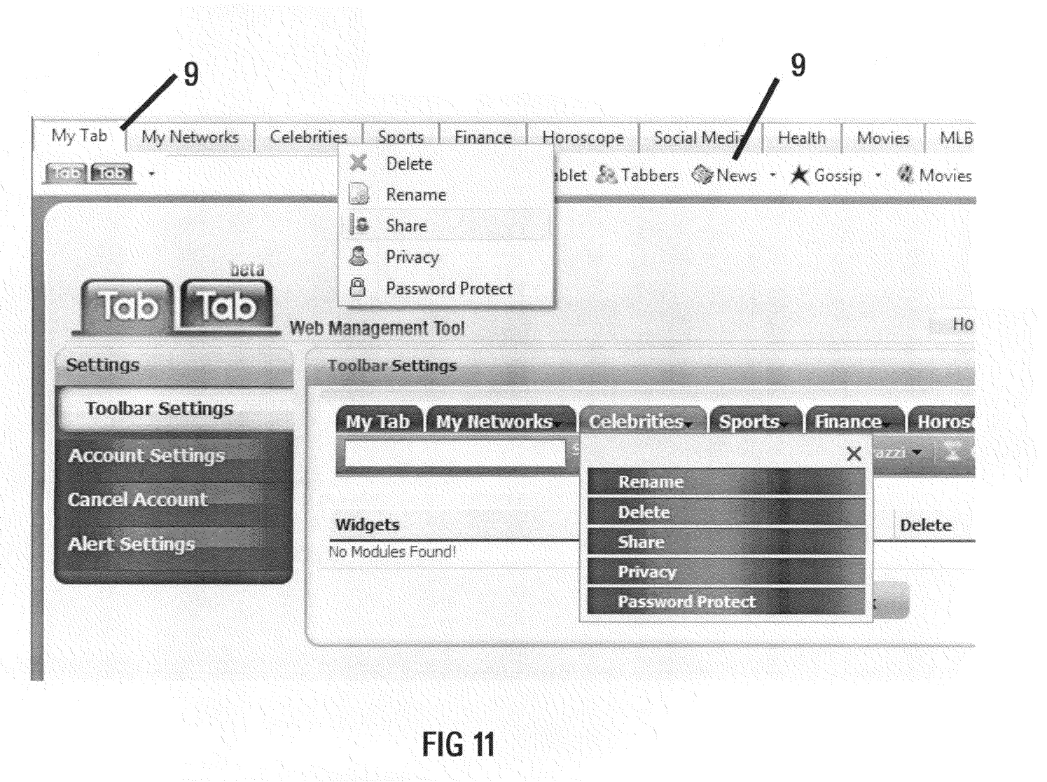

FIG. 12 shows one embodiment of sharing a widget with other users.

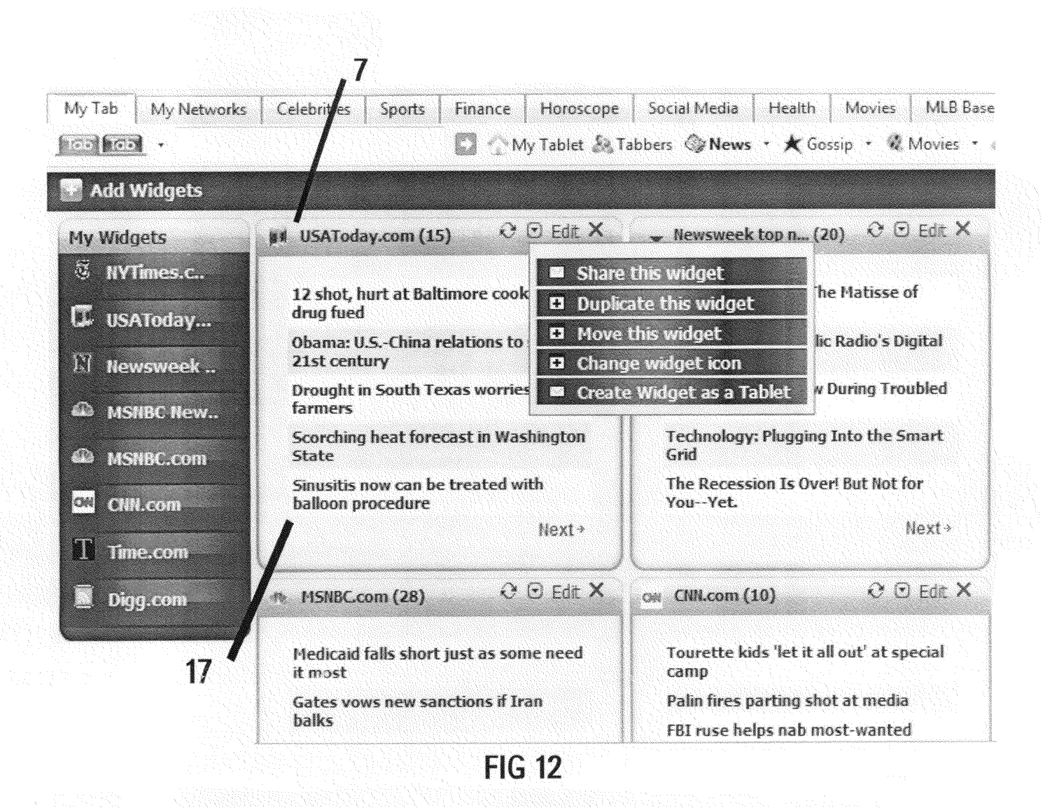

FIG. 13 shows one embodiment of share widget page with other users.

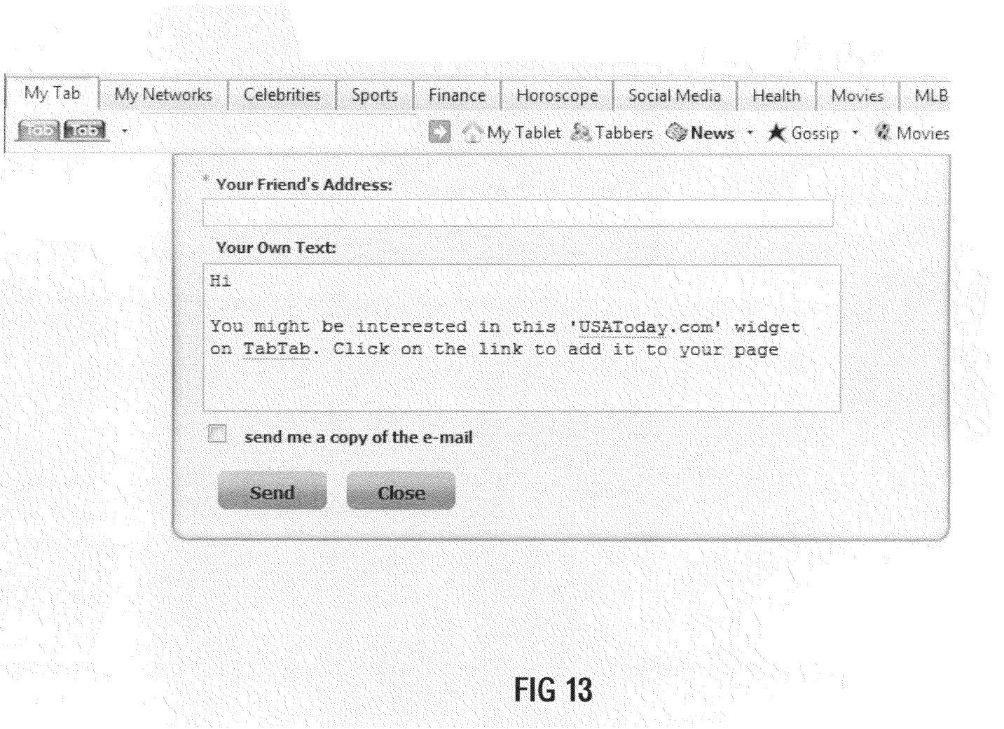

FIG. 14 shows one embodiment of tabtab alerts due to updates.

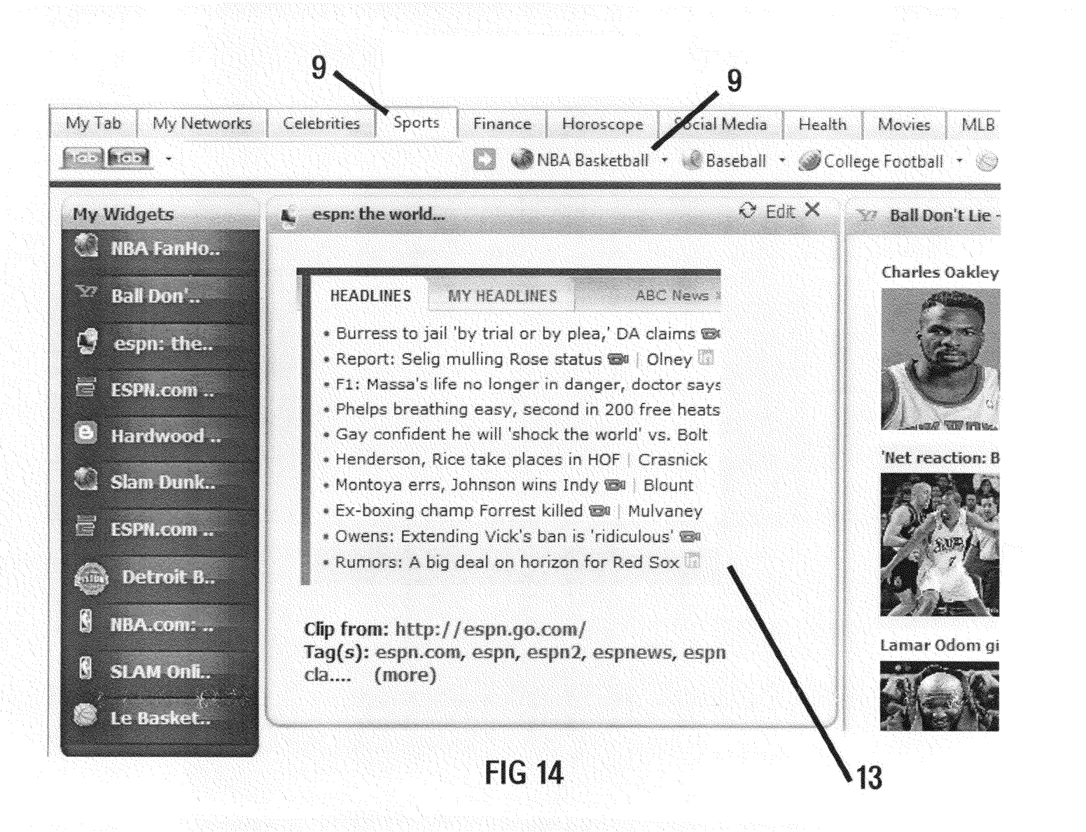

FIG. 15 shows one embodiment of tabtab listing of snippet history.

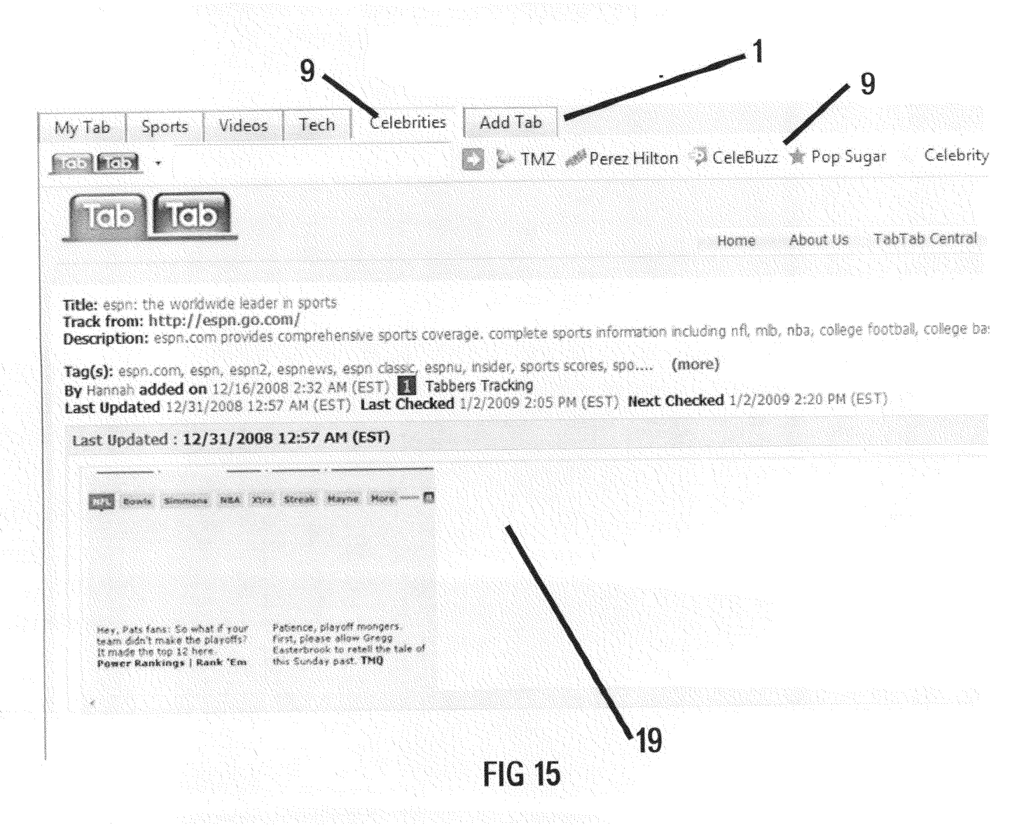

FIG. 16 shows one embodiment of adding widgets page.

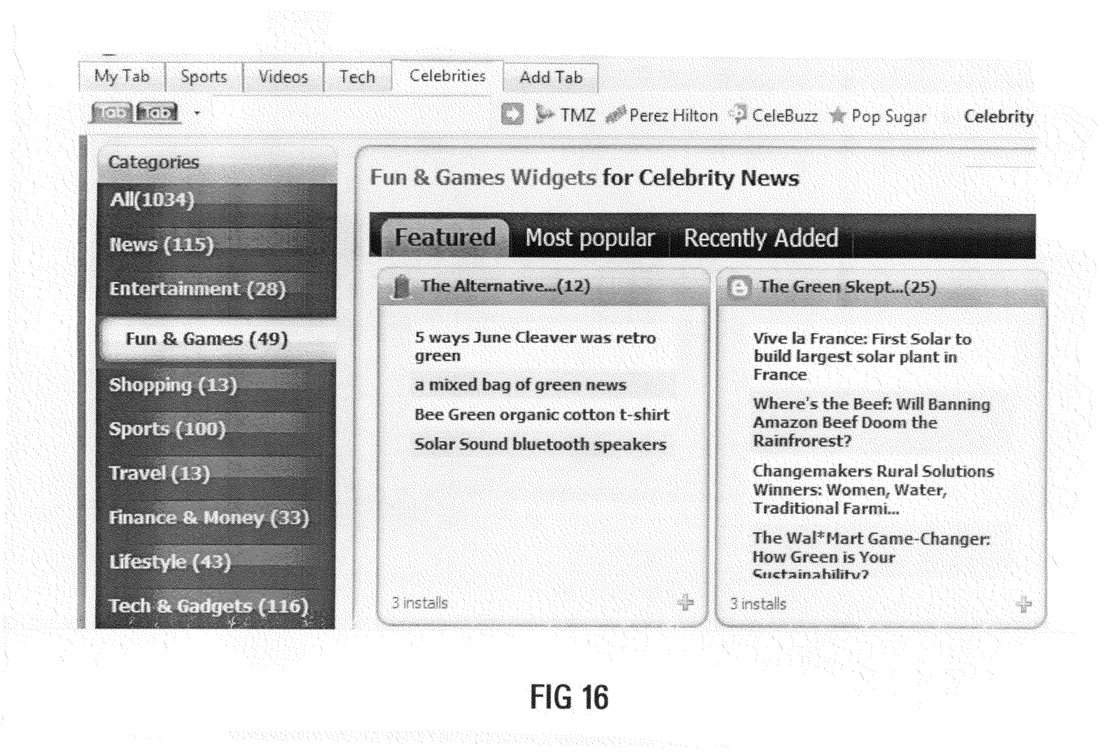

FIG. 17 shows one embodiment of adding widgets menu.

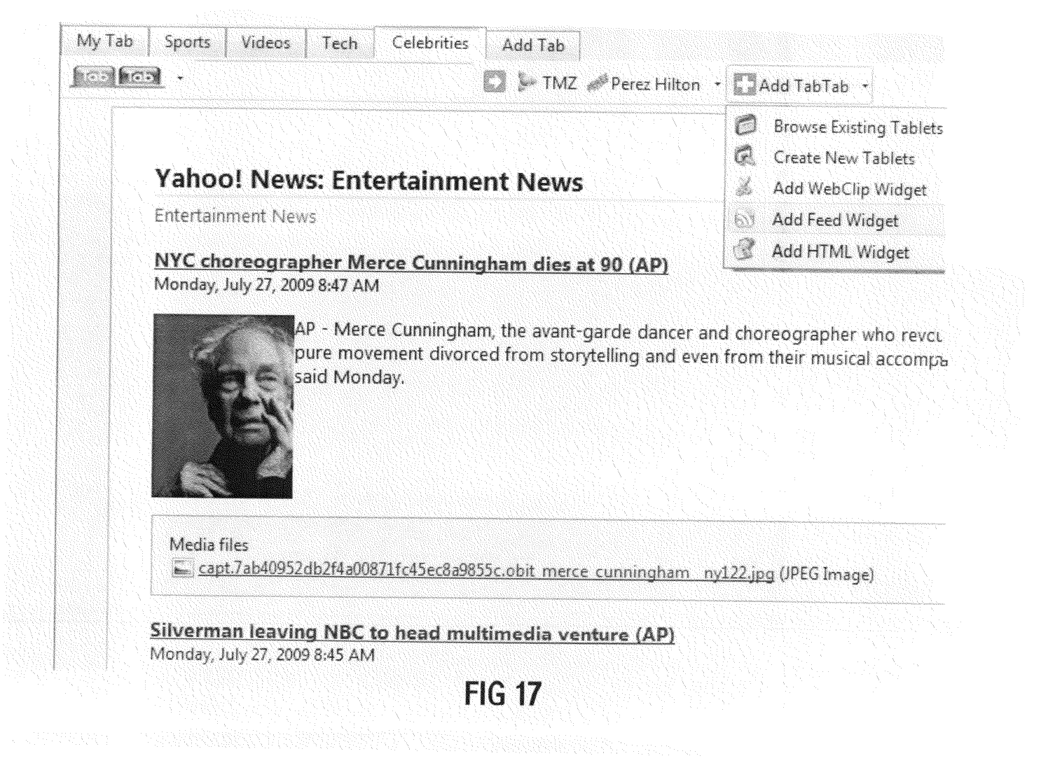

FIG. 18 shows one embodiment of creating new feed widgets to a tablet.

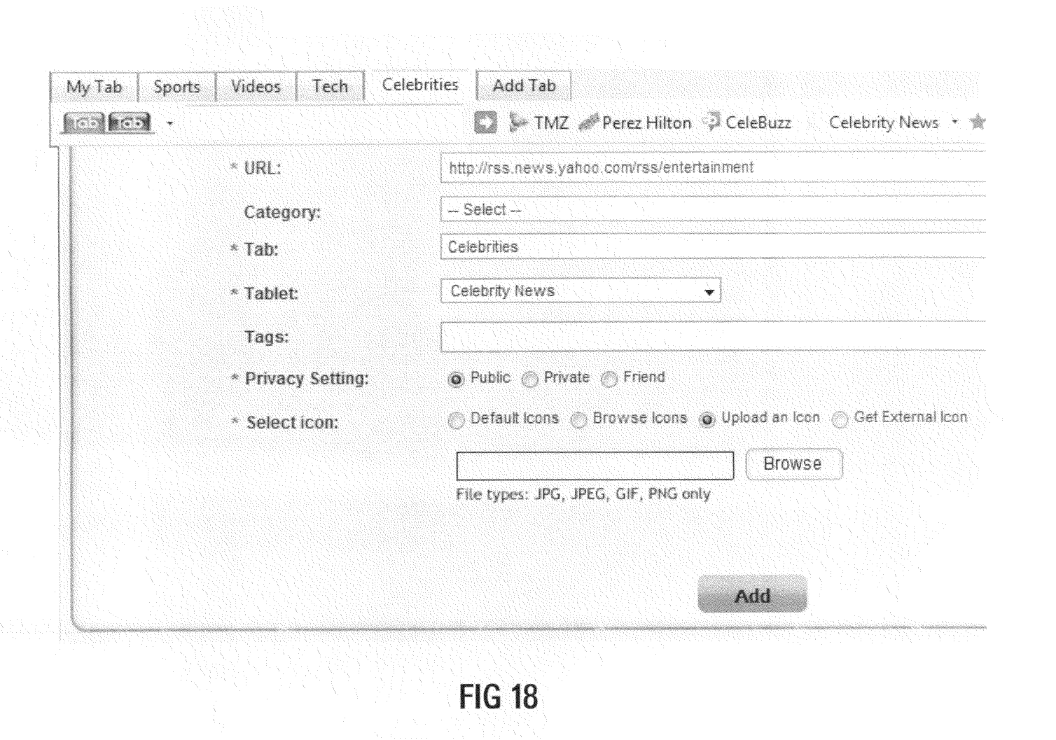

FIG. 19 shows one embodiment of added feed widget.

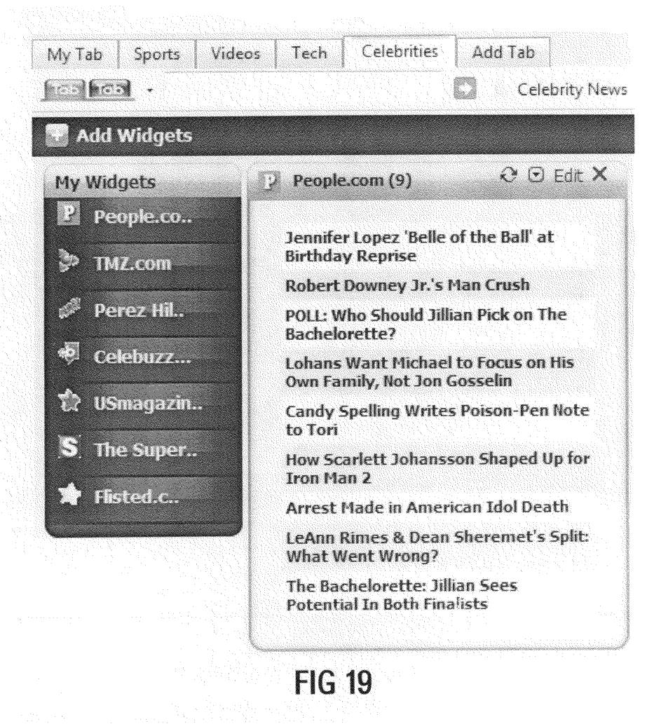

FIG. 20 shows one embodiment of the add feed widget page.

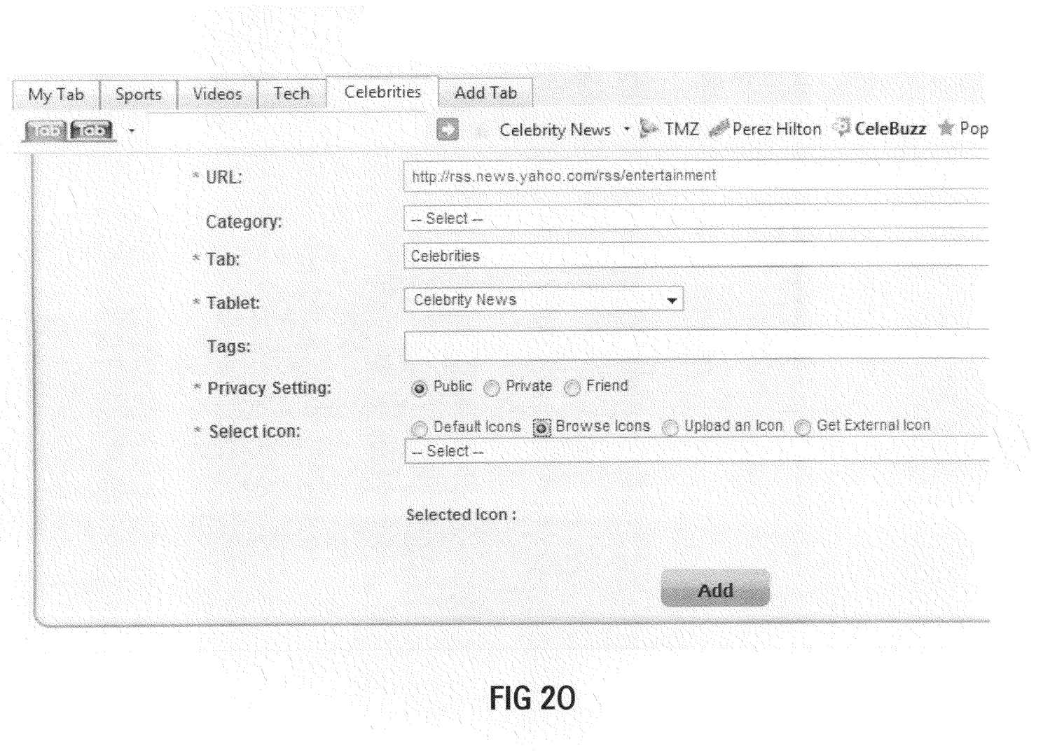

FIG. 21 shows one embodiment of the create new html widget.

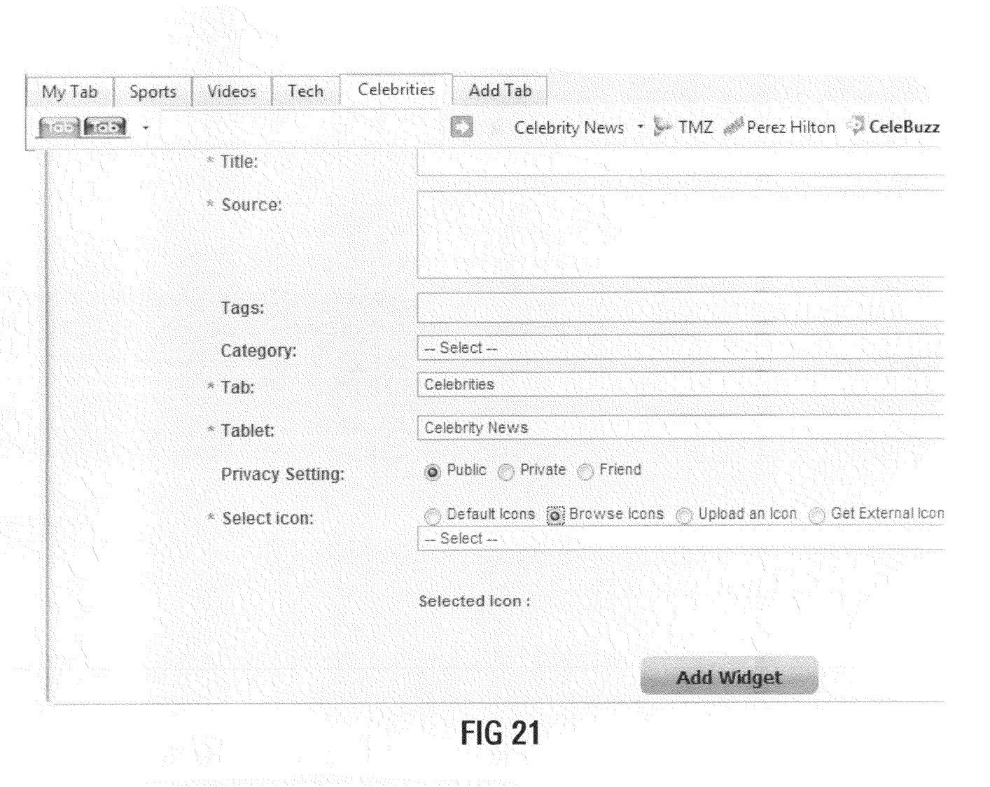

FIG. 22 shows one embodiment of add external widget.

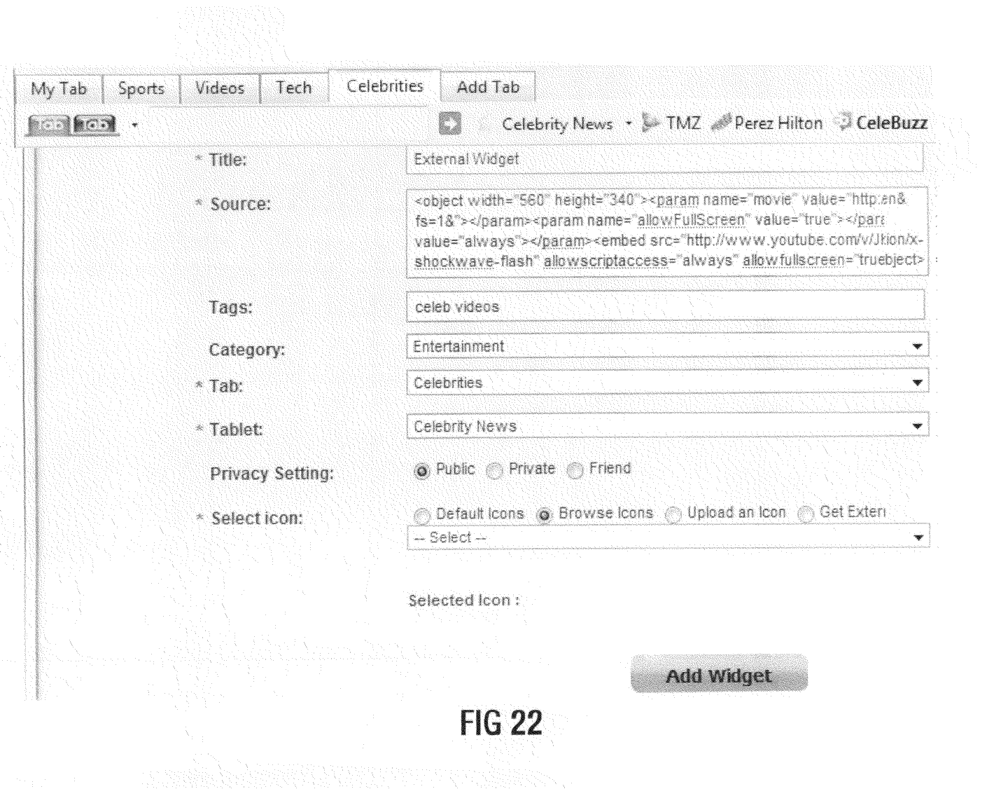

FIG. 23 shows one embodiment of add search widgets.

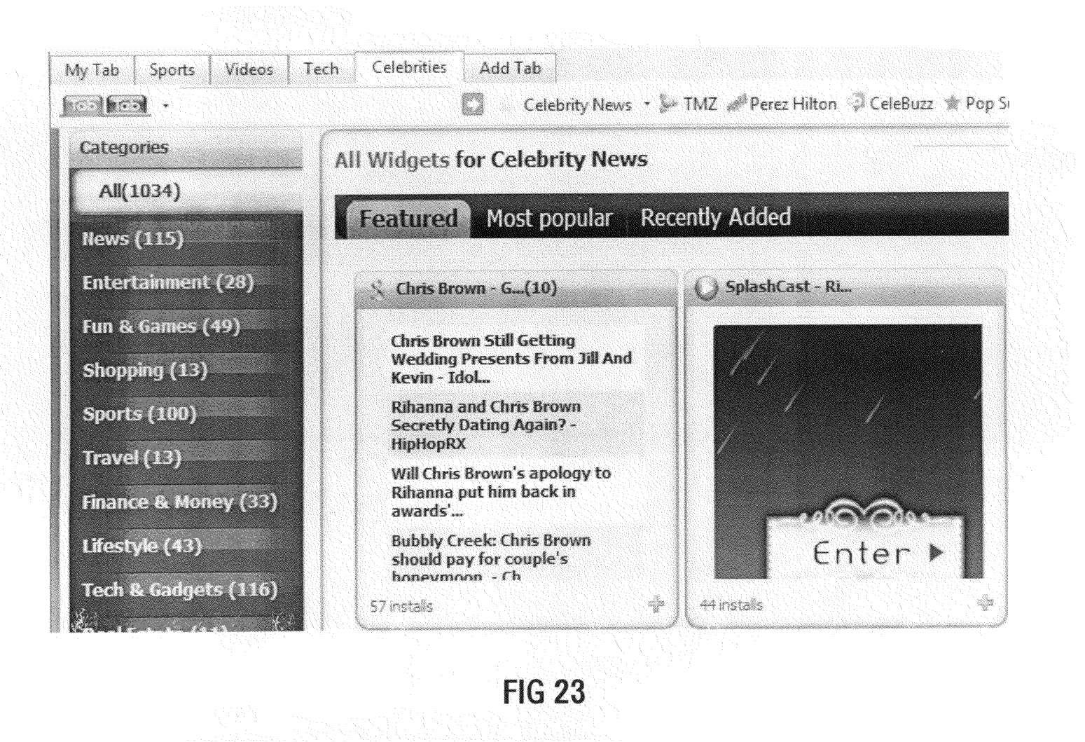

FIG. 24 shows one embodiment of add search widget category.

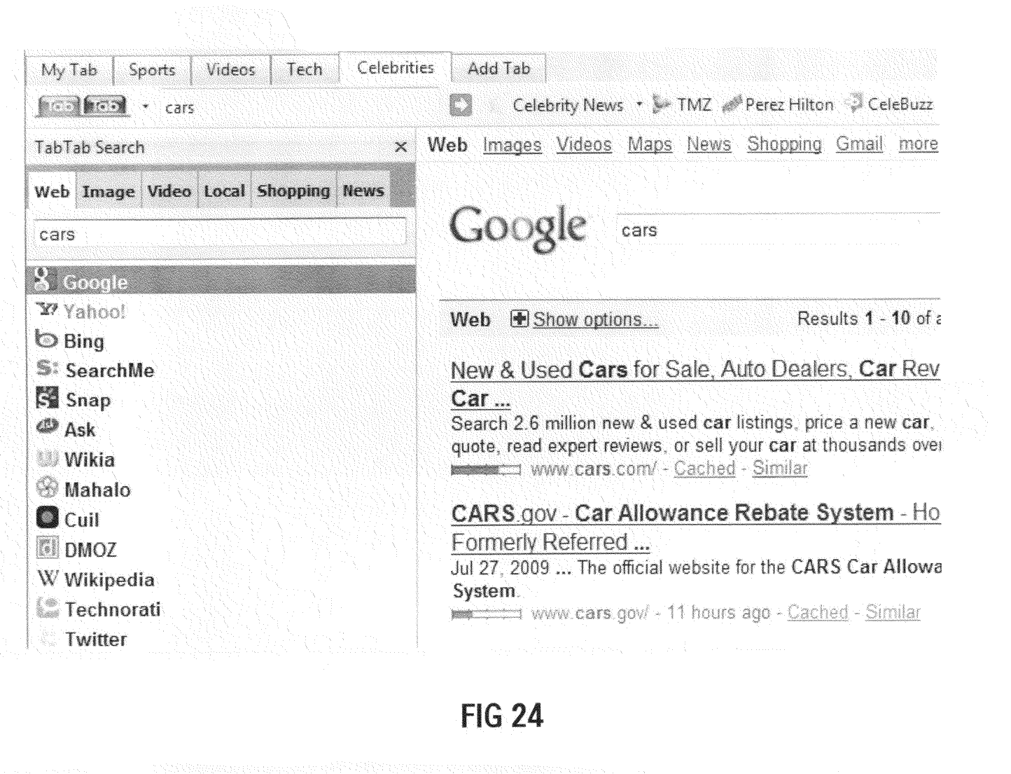

FIG. 25 shows one embodiment of other tabtab users page.

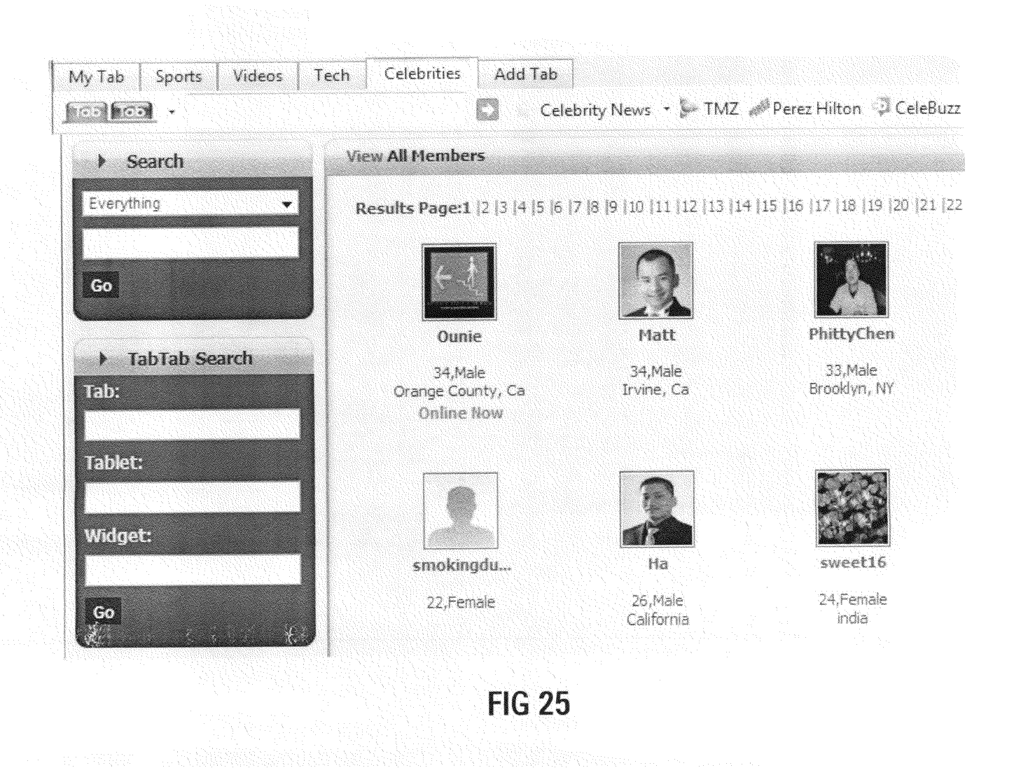

FIG. 26 shows one embodiment of copy another user's tab.

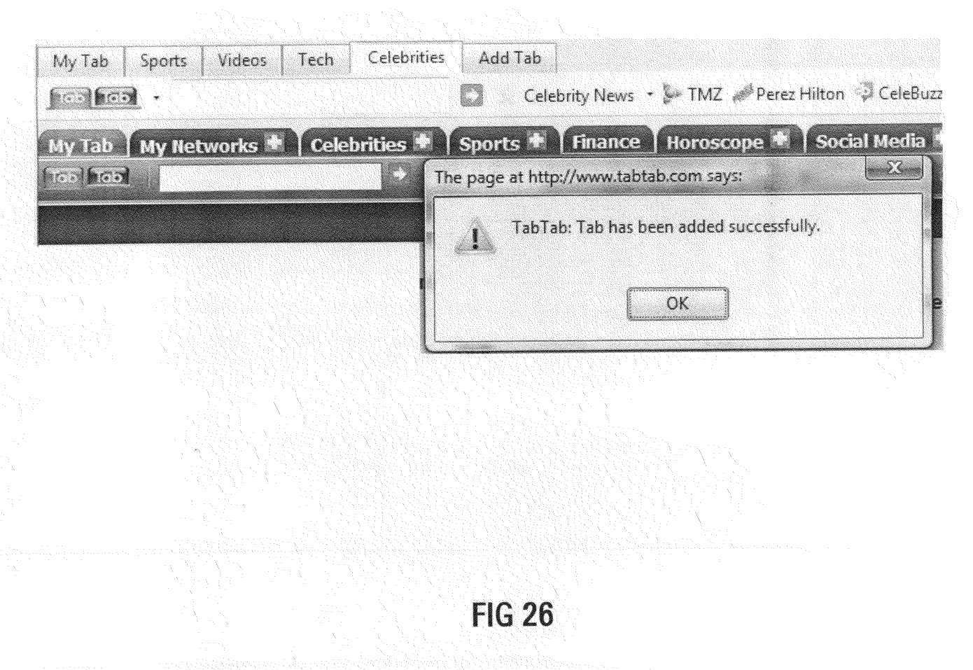

FIG. 27 shows one embodiment of copy another user's tablet.

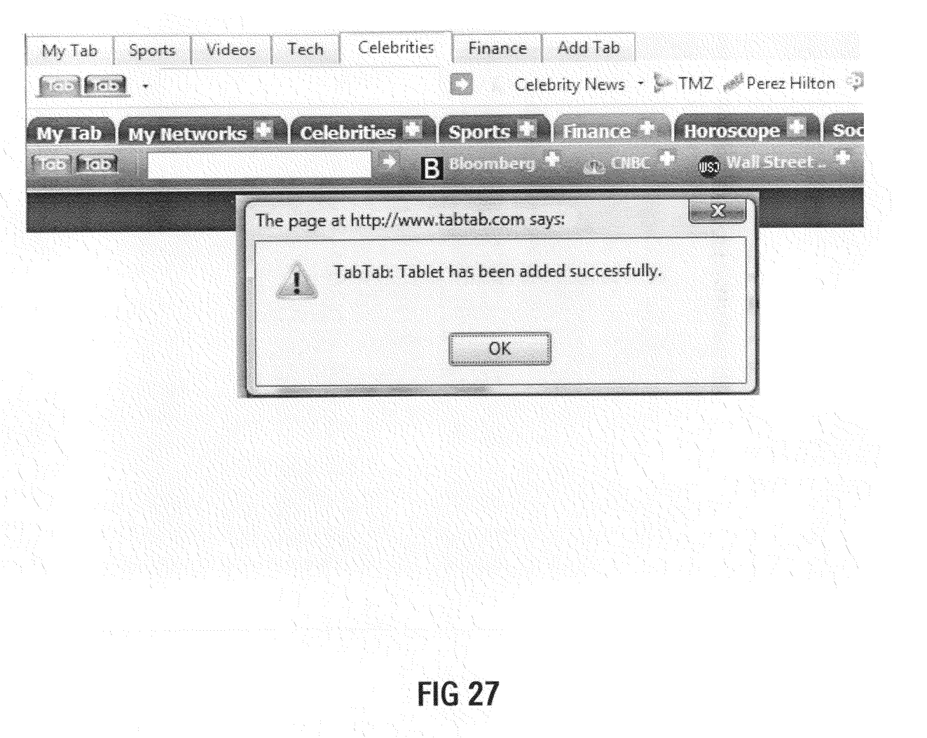

FIG. 28 shows one embodiment of copy another user's widget.

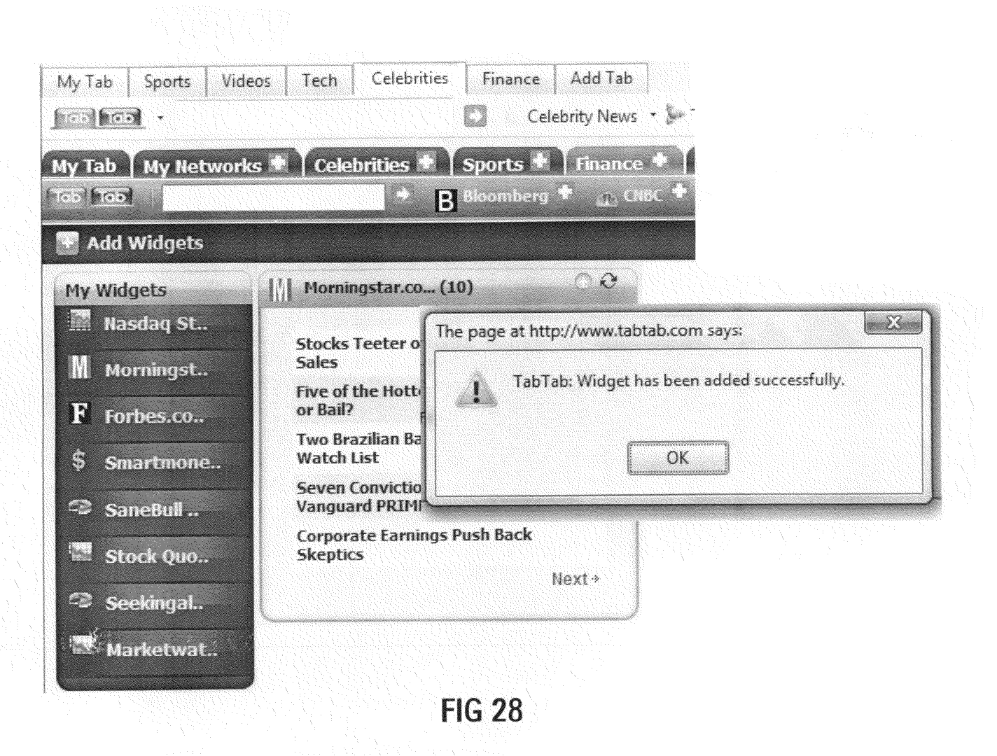

FIG. 29 shows one embodiment of tab of another user added.

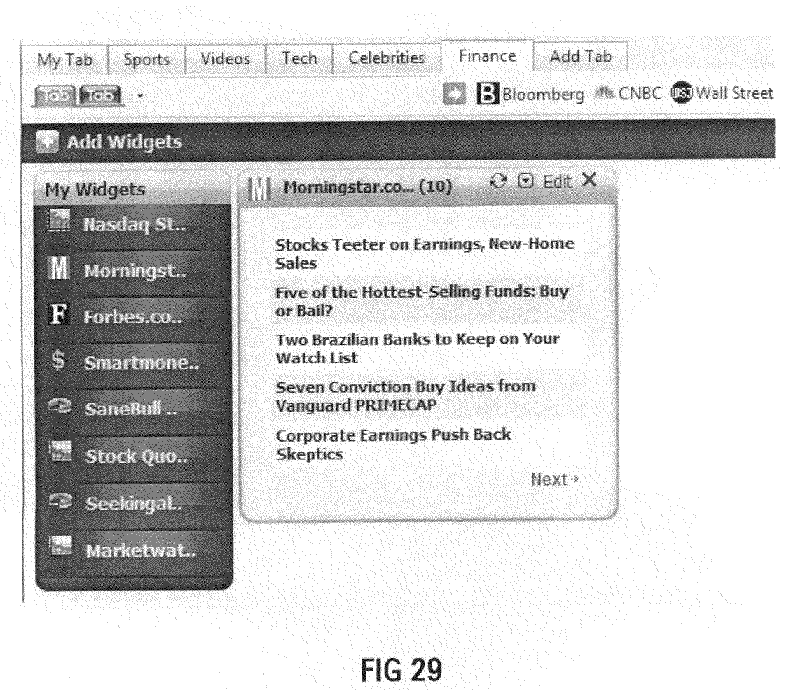

FIG. 30 shows one embodiment of tabtab toolbar settings.

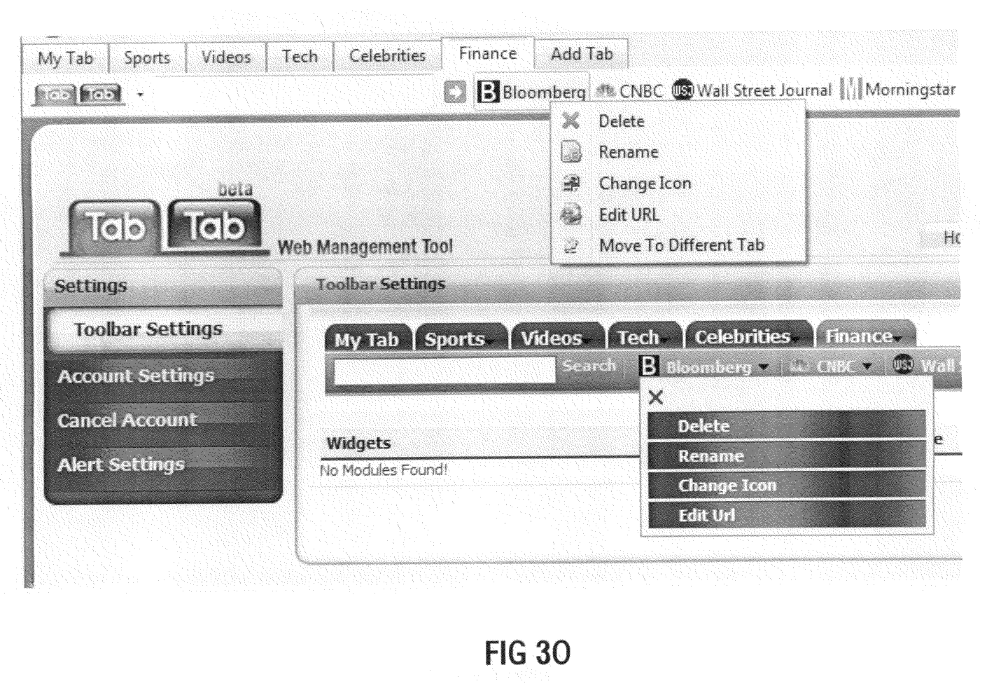

FIG. 31 shows one embodiment of opening applications using a tabtab tablet button.

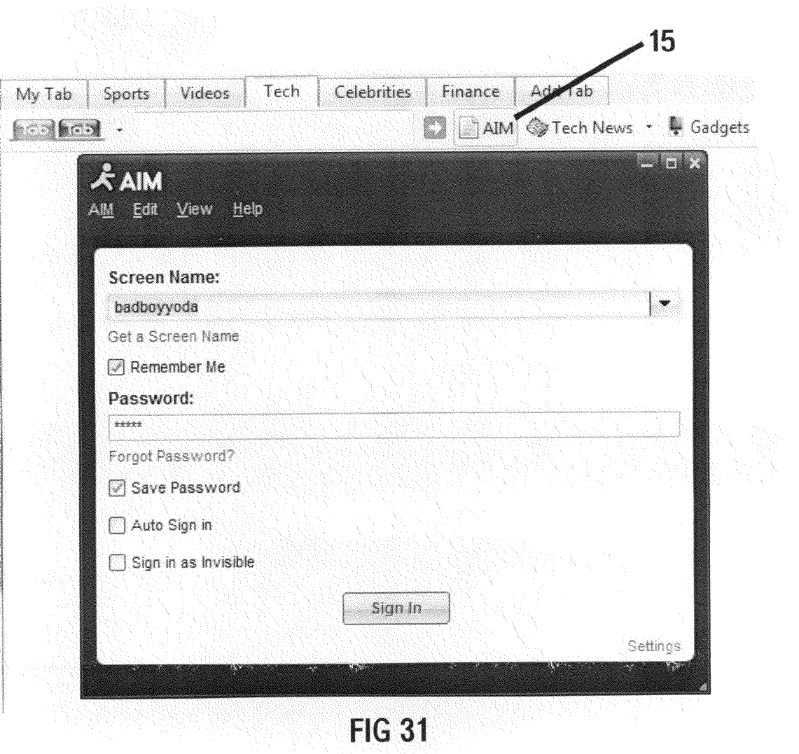

FIG. 31 shows one embodiment of opening a file directory using a tabtab tablet button.

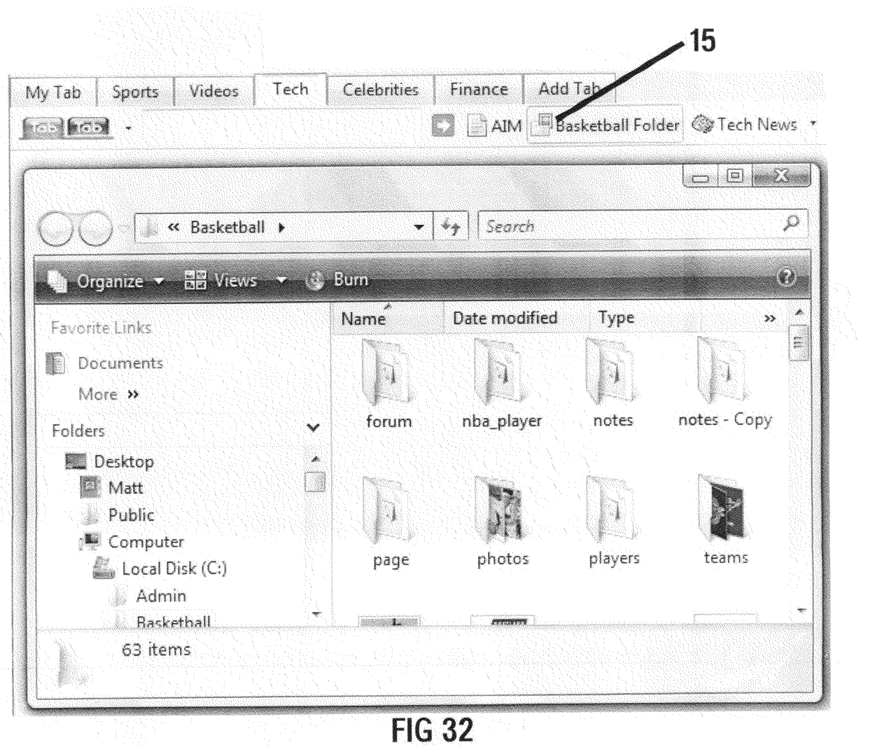

FIG. 31 shows one embodiment of adding url onto toolbar.

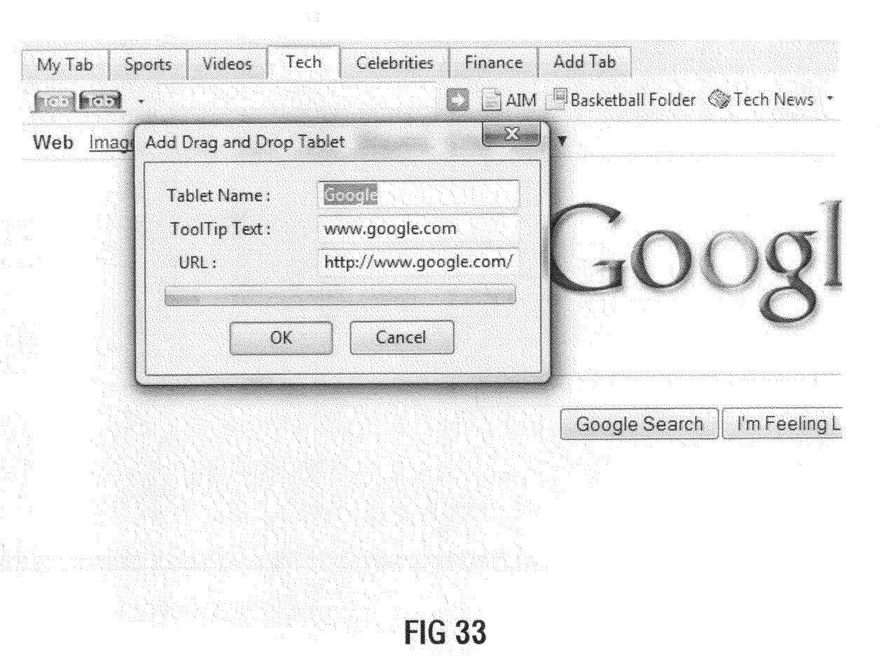

### DETAILED DESCRIPTION OF EXEMPLARY EMBODIMENTS

The server serves an active advertisement object related to the product. The active advertising object may comprise a widget 17. Widgets 17 may be placed within customized tab 1 categories setup by said user to efficiently surf the internet with associated automatic updates, searches, as well as directed advertisements. The widget 17 is an interface element that a viewer or user may interact with. The active advertising object comprises a user interface that can be replicated on a user's request. The active advertising object may include, without limitation, a display including an advertisement which may include for example, a company logo, a price of the product, an image of the product, a commercial message related to the product, and any other text, graphics, video, sound, or multimedia elements that are used in advertisements. The active advertising object may also comprise buttons for a user to click on or select, and forms into which the user may enter information. The active advertising object comprises code that when executed on a computer causes the active advertising object to be displayed (e.g. on a web browser) on an Internet connected computing device. It is understood by those having ordinary skill in the art that many different types of code are possible for example, without limitation, html code, flash code, javascript code, and the like.

With Java, developers can create robust User Interface (UI) components. Custom “widgets” (e.g., real-time stock tickers, animated icons, website snippets, search engine gui, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

In embodiments, the display of a tab portal facility may include a “widget” 17 to answer a user's query, help a user to disambiguate their query, guide a user deeper into content properties, and bubble up the most popular and/or relevant content. Widgets 17 may utilize structured and semi-structured data to help users to minimize searching for content and answer a user's queries directly. In addition to the query classification, a learning algorithm may use click and impression analysis to determine when an answer/result should be shown, where on the page it should be shown, and/or how much content from a given source should be displayed. While the algorithm may determine the correct results set, it may be possible to inject editorial overrides and influence the display of content for queries based at least in part to actively manage/merchandise query results.

In an additional embodiment, the user, merchant, tab portal partner, and publisher may be the same party. For example, an advertiser with their own web site may use the system and method of the present invention to copy and paste an HTML snippet from the video service provider to the user's tab 1 content, whereby a user (that is, a viewer) of his personal tab 1 may see the advertiser's web site may view a video data file by way of accessing an HTML video snippet from the video service provider. Thus, the HTML snippet is a web tool, i.e., a web widget 17, that may be used by a publisher and/or a partner to initiate the video uploading process that ultimately returns an HTML video snippet with which a viewer may view the uploaded video data file.

Additionally widgets 17 may be organized with widget buttons 5.

Further, a user may place a web widget 17 from a social network, or other third party website, onto his personal tab 1 category. In doing so, an ad targeting system may deliver ads for display with the web widget 17, where the ads are selected based on analytics data from the web tab 1 widget portal, obtained for the specific user. A web widget 17 illustratively includes mobile widgets 17 and desktop widgets 17.

In an example embodiment, a showcase is presented in the form of a tabbed interface widget 17. Presenting a showcase using a tabbed interface widget 17 has several advantages, such as grouping different types of information about a product, presenting certain tabs 1 to certain types of users and the like. One example embodiment of the presented system may use four tabs: 1) overview; 2) details; 3) shopper; and 4) offerer and present the overview tab 1 to general public users; present overview, details and shopper tabs 1 to shopper users and present overview, details and offerer tabs 1 offerer users. The user clicks a tab 1 available to according to the user type, i.e. public, shopper or offerer and at both, the desired tab 1 is presented to the user. The user previews and browses through various search results until finding the desired product or service.

In one or more configurations, a user of a mobile device, desktop or internet device may input desired data into the said device or organize the data within the device with a tab 1 toolbar 7 to display the information in a convenient manner. In addition, the system may include a widget 17 API for providing a standardized interface for communication between a user interface display element (i.e., a widget) containing or displaying desired information. A widget 17, as used herein, relates to a user interface element and/or application that provides information such as advertising or weather information to a user based on a variety of factors such as user preferences defined in his particular tab portal. The system API may communicate with the widget 17 via the widget API, for example. Also, the widget 17 may access information on the Internet via the widget API. The widget 17 may also include one or more web applications that are linked to one or more web servers and that access, send and/or retrieve information without relying on a web browser.

Widgets 17 may be arranged and displayed on a tab portal located in a particular area of the user interface on a desktop or mobile device. A tab portal toolbar 7, as used throughout, refers to a predefined area of the user interface in which one or more widgets 17 may be placed and organized. The tab portal provides delivery of messages from the widget API to the service or web server. The tab may further include an API interface for providing access to mobile device resources and for presenting a user interface corresponding to a widget 17. The tab API may contain at least two parts. One part may be an API for the development of widgets 17 such as design, placement on a display, content, etc. Another part of the tab API may be provided for third party developers. In another example, the tab API may be built over a mobile device operating system or over any other API available on the mobile device. In another example, the system may also include a mobile gateway for creating and maintaining mobile connections between a mobile device and a service.

Widgets 17 may be acquired in a variety of ways including through e-mail and/or by adding to the tab bar from a widget advertiser or server. For example, an on-line business may make available an advertising widget 17 associated with the business and allow users to add the widget 17 to receive discounts and other offers from the business. Alternatively or additionally, an advertising company may e-mail widgets 17 to target users. In one or more configurations, one or more users may be given an incentive to allow advertisements and advertisements widgets 17 to be added to their device such as a mobile telephone. For example, a company may offer bigger discounts through a widget 17 advertised on their website. Thus, those users who add the company's widget 17 will be able to take advantage of the discounts. Users may also be motivated to add a widget 17 as a less obtrusive and controllable system for receiving desirable advertisements within a particular tab category. Compared to other advertising methods, widgets 17 may allow a user to control when advertisements are received and/or displayed. Users may further control when the widget 17 is active.

The system further includes server that evaluates advertisements received from merchants and may deliver one or more of those received advertisements to a user's tab portal. Database, also included in the system, stores a multitude of information including user preferences, user tabs 1 content, specific user interest based on tab categories setup, user operation patterns and a record of a user's collection of widgets 17 within tabs 1. Thus, server may control and restrict the distribution of private user information to only user authorized entities. Various restrictions and permissions may be specified user upon registering with server or an underlying system. According to aspects, server may be restricted from distributing any information related to a user unless given express permission. Mobile device may become associated with server by a user of device subscribing to server. Alternatively or additionally, device may be associated with server by a default setting pre-installed by a mobile service provider or a mobile device manufacturer. Mobile device includes various components including a display screen displaying user interface.

User interface further includes a tab portal and multiple widgets 17 situated within the tab portal. Tab portal may be defined by a fixed area of the user's interface that is dedicated to displaying one or more types of information group by user preference such as widgets 17. The area occupied by tab portal may be set by the user or predefined by a system default. Tab portal may also be a flexible area that expands or contracts depending on the amount of information to be displayed. In instances where tab portal is a fixed size, advertisements and widgets from various advertisers and companies may compete for space on a particular user's tab portal. In some cases, one spot, for example, the middle of tab portal, may be more desirable than a left or right position.

Each of widgets 17 that are downloaded through widget server based on one or more of a user request, user preferences and/or user operation patterns stored in database. In particular, database may track and record a user's preference for certain types of advertisements or advertisement widgets 17 to build a user profile. Specifically, widgets 17 collected by a user or specific search requests may be analyzed and recorded as part of the user profile. For example, a user's widget collection may contain more advertising widgets 17 related to consumer electronics than sports memorabilia. By inferring a preference based on the user's collection of widgets 17, server may assign higher priority to advertisements related to electronics and lower priority to sports memorabilia advertisements. The user profile is stored to allow server 300 to transmit only relevant and desired advertisements to the user. Irrelevant or unwanted advertisements may be parsed out by widget server or, alternatively, may still be sent to device depending on the user preferences and device settings.

Widget advertisers may compete to have their advertisements transmitted to device tab toolbar 7 user interface. Widget advertisers refer to those companies or organizations that seek to advertise widgets 17 to users. The advertised widgets 17 may be specific to a company and contain functionality and/or information that are particularly relevant to or indicative of the sponsoring company. On-line advertising systems and vendors, on the other hand, generate advertisements for various companies and organizations and transmit the advertisements to server. That is, the advertisements distributed by on-line advertising systems might not be relevant or linked to systems. Server may generate an advertisement widget for the advertisements received from on-line advertising system using, for example, a widget template or, alternatively, may deliver the advertising information through an advertisement widget previously downloaded to a user's device. As such, advertisements from on-line advertising system and widget advertisers compete for a user's attention.

Server is responsible for resolving the competition and determining which advertisements are ultimately transmitted to which users. In particular, server segments the user population to determine which users receive a particular advertisement. To do so, server may retrieve user information and profiles from database, divides the user population into segments, and determines which segments receive which advertisements or advertisement widgets 17. For example, server may determine, based on user interaction patterns and user profile information, including widget collection data, tab creation data, that users in the 18-25 year old demographic living in New York are disproportionately interested in advertisements related to luxury goods while users in the same age demographic living in California are more interested recreational goods.

Alternatively or additionally, user profiles may be updated every time the users corresponding to user profiles downloads or updates their collection of widgets 17, create new tab categories. A user may further manually update their profile based on a change in preference or other factors. In addition to the aforementioned information, user profiles 401 and 402 may also include information such as widget usage history 19 or web snippet/web clip history 19. In one example, user portal may include an information tab named “Favorite Football Team” with an associated value of “Washington Redskins.” In contrast, user profile might not contain that tab, but instead may include a field named “Historical Era” indicating that the user is especially interested in the Middle Ages. As such, each of user profiles may contain profile information that relates specifically to a particular interest of the corresponding user, e.g., tab categories.

Widgets 17 such as widgets 17 may be associated with a single advertisement or may be used to display and rotate multiple advertisements. For example, a widget may be generated that is specifically associated with a particular product such as a beverage. Accordingly, the widget may only displays a pre-specified advertisement associated with the advertised beverage. Alternatively, a widget may be generated that is capable of receiving and displaying multiple advertisements that may be related in subject matter or associated with the same company. In one instance, a company that sells several types of furniture products may create a single widget that is capable of displaying a rotation of advertisements relating to the various types of furniture products. Additionally, a server may generate a single advertisement widget for receiving and displaying an assortment of advertisements that the server determines are relevant to a corresponding user.

Advertisers can select to use Sponsor Widgets 17 to promote their products. TabTab evaluates the sponsor website continuously, so, as Sponsor content changes, TabTab will dynamically alert users on the TabTab tab portal toolbar 7 that there's a product match with their set criteria. Advertiser can select from 4 different methods to update TabTab of their advertised products.

### Types of Widgets 17 Advertisement:

1. Sponsor Widgets 17. This is company specific widget. For example, Honda can have their own Honda Sponsor Widget that will feature only their products.
2. TabTab Widget's with Sponsor Ads. TabTab create generic category widgets 17 that Advertisers can be part of. If advertiser's sponsor ad matches the user's criteria then the ad will be display in the widget. For example, TabTab have a car search widget. User enters what kind of car they are looking for. TabTab brings back 5 results that match the user's criteria. Honda is a sponsor ad and is on the list because it fits the user's search criteria.

### Create Sponsor Widgets 17:

1. Advertiser can choose to create their own widgets 17. TabTab will provide an Open API (Application Program Interface) so Advertiser's sponsor widget can communicate with TabTab's database.
2. Advertiser's can have TabTab create the sponsor widgets 17 for them for a setup fee.

### Four Methods to Analyze Advertiser's Website for Updates:

1. Direct Access to Advertiser's database
2. Send Crawler to spider Advertiser's website
3. Slice Code for Advertiser's top on their website
4. Advertiser Clip section of their website
   1. Direct Access to Advertiser's database:

TabTab will provide an Open API (Application Program Interface) so Advertiser's can push updates from their Database to TabTab's database.

2. Send Crawler to spider Advertiser's website:

TabTab sends a crawler to detect and analyze the content of Sponsor's website to determine if the product offers matches the user's selected criteria.

3. Slice Code for Advertiser's top on their website:

Advertiser can enter a slicing code, <Div id=TabTab1> Content </Div>, on their website. This will allow TabTab to crawl and detect the Sponsor products and any updates within the slicing code section.

4. Advertiser clip sections of their website they want to advertise:
Advertiser can use TabTab's WebClip feature to clip section of their website. TabTab will use WebClip crawler to analyze any new updates within the clipped section.

### Advertiser's Enter Information in Database:

When Advertiser decides to partner with TabTab they'll need to sign up with their TabTab user id or register with email address. They'll need to enter their name, address, phone, and credit card information. Their credit card will be charged base on the form of advertisements they select.

There are Four Ways TabTab Makes Money from Sponsor Widget:
1. CPC, or Cost-Per-Click ads. Each time a user clicks on a Sponsor ad widget on TabTab website or from the user's Tablet page. (CPC ads are also known as PPC, or pay-per-click ads.)
2. CPM, or Cost-Per-Thousand Impressions. When a user views a sponsor ad widget either from the user's Tablet page or from TabTab's website.
3. Referral Fee. When TabTab refer a user to a Sponsor Website, TabTab will receive a set percent referral fee based on the commissions earned by the purchase made by the user.
4. Installs. When a user adds the sponsor widgets 17 to their Tablet, Sponsor will be charge a set price for per install.

### User Add Sponsor Widgets 17:

1. User goes to TabTab website and search for widgets 17 based on their interest.
2. TabTab brings back a list of widgets 17 including Sponsor Widgets 17.
3. User decides to add a Sponsor Widget to their Tablet (Tab portal toolbar button that have widgets 17).
4. User enters criteria they are interested in. For example, User add a Travel Sponsor Widget, user will enter dates they want to travel, destination, and price threshold.
5. TabTab returns the results from the enter criteria.

### Sending Alerts 9 to User's Tab Portal Toolbar 7 on Updated Widgets 17

1. User set alert setting. User can set alert on or off, and user can set alert time interval, for example every 15 minutes.
2. TabTab will notify the user directly on the Tab portal toolbar Tablet button when there's a match with the user's criteria.
3. Tab portal toolbar tab is highlighted and there's a number count of updated widgets 17 next to the Tablet button. For example, Travel (2) indicates that the Travel tablet button have 2 widgets 17 that matched the user's set criteria.
4. User click on the tablet and the tablet page is open in the web browser.
5. The updated widgets 17 are highlighted to indicate which widgets 17 have new updated information.
6. When the user click on the updated widget the count on the Tablet is decreased.

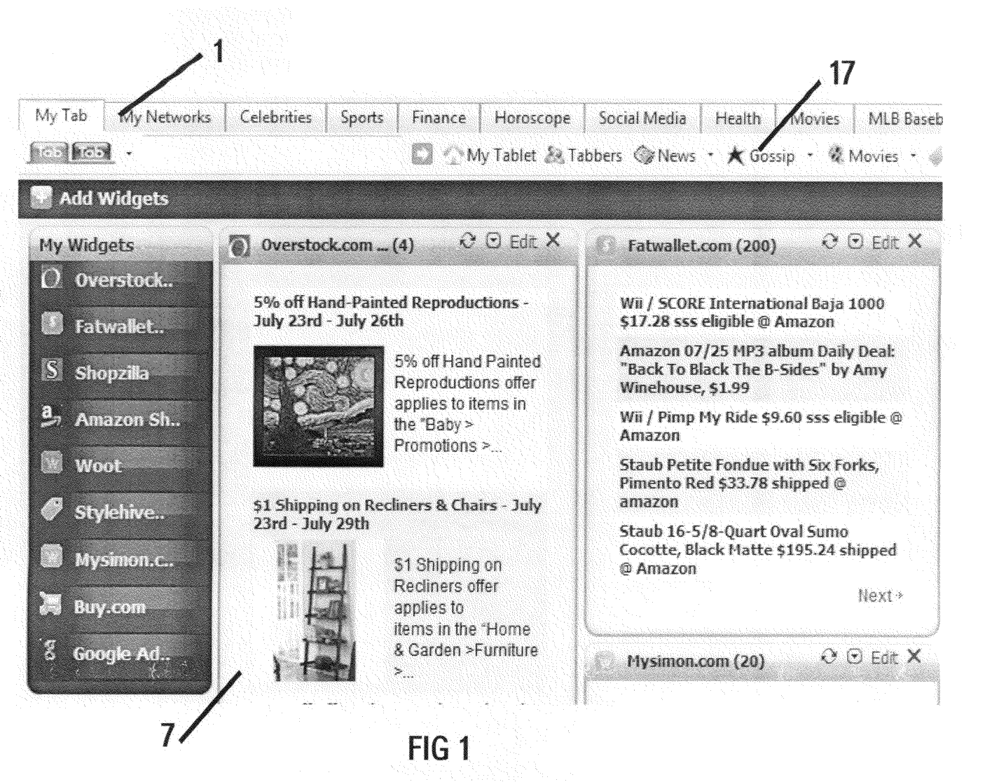

As shown in FIG. 1, a computer is connected to the Internet. Computer includes an internal bus that facilitates communication of information (i.e., digital data) between and among the various devices of the computer and that also facilitates communication between the computer and external devices and systems via a communication interface. A processor coupled to the bus processes information within the computer. The computer also includes a memory such as, for example, Random Access Memory (RAM) and/or other equivalent dynamic memory storage devices, coupled to bus for receiving and storing instructions communicated from the processor. Memory may also be used to temporarily store variable or other intermediate information while the processor executes instructions. Read-Only-Memory (ROM) is also coupled to the bus for storing static data and instructions for use by the processor.

Various input and output devices are provided as part of computer, including, by way of non-limiting example, a display 154 (e.g., cathode ray tube (CRT), liquid crystal display (LCD), etc.), an input device such as a keyboard, and a cursor control device such as a mouse, or trackball, for example. A data storage device such as, for example, a magnetic disk drive and magnetic disk, a CD-ROM drive and CD-ROM, a DVD-ROM drive and DVD-ROM, or other equivalent devices and data storage mediums, is coupled to the bus for communication with the processor, main memory, and communication interface. The storage device preferably has an operating system and an Internet browser software program (i.e., a browser) stored thereon. As will be discussed in greater detail below, a client-side module may also be stored on the data storage device.

The computer may communicatively connect to the Internet via the communication interface over one or more transmission media including, but not limited to, coaxial cable, copper wires, and fiber optical cables. Communication between the computer and the Internet may also be via a wireless or cellular interface. The communication interface facilitates two-way communication between the computer and another electronic device or system, e.g., a server computer or computers provided by a content provider.

An Internet user using the computer may gain access to the Internet by causing the browser to execute, thereby opening a communication link between the communication interface of the computer and an Internet site of content provider, via an Internet Service Provider (ISP). Internet content is communicated by the content provider to the computer for display by browser. Alternatively, a content provider may also be an ISP.

In alternative embodiments, computer may be a desktop or notebook computer, PDA, hand held device, or wireless phone (with graphics capability), or any other device now known or hereafter developed that is capable of performing the functions as described herein.

In accordance with an embodiment of the invention, Tab portal toolbar 7, the content provider for the tab portal toolbar 7, may provide an Internet user with access to a program for controlling the browser. When executed by the user, the controlling program downloads or creates a client-side module such as, for example, a Dynamic Link Library (DLL), on the data storage device of the Internet user's computer. The client-side module preferably includes ActiveX control or Plug-in functionality. Thereafter, when the Internet user accesses the Internet using the browser, the browser opens the client-side module and preferably automatically establishes a connection to the content provider's Internet site. The content provider, in response to the connection established by the browser, loads information and/or functional data into a shell operating within the browser and created by the client-side module. For example, if the user has an account with Tab portal toolbar 7, customized information and/or functionality may be loaded into the client-side module. If the user does not have an account, more generalized (e.g., guest) information and/or functionality may be loaded.

The client-side module essentially opens a shell (or a plurality of shells) within the browser that contains the ActiveX control or Plug-in code that may control, i.e., add, remove, and/or modify, the Internet browser, alternatively the current invention may reside in a stand alone window. When loaded with the ActiveX control or Plug-in, the client-side module preferably contains functions, objects, data, and other software, referred to generally herein as information, that may be used to control the browser. The present invention ensures that the client-side module (and shell) does not close when the Internet user moves, for example, from Internet to another. Thus, the information and/or functionality provided via the ActiveX control or Plug-in is not lost when the Internet user disconnects from the Internet site that loaded the ActiveX control or Plug-in, and connects to another Internet site. In alternate embodiments client-side module may be located at a remote location from the Internet user. The client-side module takes the form of customizable toolbar 7s.

An embodiment of the invention may be provided as a feature of a method of controlling an Internet browser interface displayable by an Internet browser on a display of a computer, and enabling a user of the computer and Internet browser to access and navigate the Internet, receive updated information on targeted websites and to receive and display on the computer display one or more Web pages from one or more Internet sites, including the display of a Web page from a predetermined Internet site, the Internet browser having at least one Internet browser tab portal toolbar 7 having at least one tab portal toolbar button providing a predetermined functionality to the user of the computer and Internet browser, the method can comprise providing, at the predetermined Internet site, access to a program for controlling the Internet browser interface and making available for downloading by the predetermined Internet site, a file for causing the display of a persistent user tab portal toolbar 7 adjacent to said Internet browser tab portal toolbar 7 so as to create the visual impression that the user tab portal toolbar 7 is an integrated part of the Internet browser, the user tab portal toolbar 7 making additional functionality that is not part of the Internet browser prior to download available to the user after download as part of the Internet browser interface, such that once the user tab portal toolbar 7 is displayed the user tab portal toolbar 7 remains displayed and said additional functionality remains available to the user regardless of a subsequent Internet site to which the Internet browser is caused to navigate after download.

The method of controlling a browser may be implemented using, by way of non-limiting example, a downloadable tab portal toolbar 7. An Internet user may customize the browser so that each time the user accesses the Internet using the browser, user-defined information and/or functionality, e.g., a customizable button on a tab portal toolbar 7, will be displayed with the browser interface. In addition, the tab portal toolbar 7 may also include MyBarTab, search, tabbers tablet, add Tablet, bookmark tablet, feeds tablet, photos tablet, videos tablet, podcast tablet, music tablet, email tablet, news tablet, and inbox tablet.

The customizable button acts like a typical tab portal toolbar button, except an Internet user can edit the title, the Uniform Resource Identifier (URI), and displayed icon related to the button. When the tab portal toolbar 7 is executed, the client-side module can receive some, none or all of the tab portal toolbar buttons from Tab portal toolbar. The tab portal toolbar buttons and their characteristics may be obtained through a feed from Tab portal toolbar, the content provider to the client computer.

The request for customizable buttons may be part of a request for the contents of a downloadable tab portal toolbar. The request may be an explicit request for customizable button characteristics and/or a content provider may automatically send customizable button characteristics in response to a general request for tab portal toolbar content. In an embodiment of the invention, before the request for customizable button characteristics is received by the server, the user at client would sign into or open a new account with the Tab portal toolbar. In that embodiment, no customizable button is displayed until the user signs into an account.

Having an account with the content provider and allowing Tab portal toolbar to store button characteristics allows multiple users who use the same computer to each have their own button characteristics when using the same computer. Another benefit of certain embodiments is that the same user can use his or her personalized button characteristics at different computers without having to re-set those characteristics at the different computers. Alternatively, if the client does not have an account with the content provider or the client is not signed in, the content provider may transmit standard or generic button characteristics.

In the preferred embodiment, users can create Tablets 15 on the tab portal toolbar which launches multiple applications in a Tablet Window. This Tablet Window can serve as a startup page, a collection of modules, or information for a particular interest. With the Ajax features it will make it easy for users to organize and personalize their toolbars and tablets 15.

Alternatively, users can browse other user's tab portal toolbar and tablets 15 in the community and replicate their tab portal toolbar and tablet if they find it useful. Users can add on and improve on existing toolbars and tablets 15 making it even more useful and contain more content for everyone in the community. Users can share and improve on tab portal toolbar—adding more functions and content for users.

Users may also share and improve on tablet—adding more functions and content for users. Users can create specific tab portal toolbar that they can use and share only with people they choose. Ideally Tab portal toolbar will eventually be a central place where users can do anything online, just from a tab portal toolbar by bypassing useless information on the internet. In an alternate embodiment Tab portal toolbar will allow users to share and send useful content to other users.

A tab portal toolbar community will exists where users can not only network with each other but contribute back to their community by sharing their content—news, photos, videos, bookmarks, feeds, toolbars and tablets 15 which others might find useful and can pass along to their friends. Users can discover new sites from other user's bookmarks. Users can receive instant alerts 9/deals on their tab portal toolbar.

Tab portal toolbar allows users in the community to actually share toolbars and tablets 15 that they personally created. Users would also be able to easily share any of their digital content with other users. One aspect of the current invention to provide a platform where tabbers can easily send each other messages, videos, photos, games, bookmarks of sites they find interesting, and whatever they would like to share. The tab portal toolbar community aims to provide tabbers with a central place that they can share, give and help each other in making their online experience a more productive, efficient, and fulfilling one.

Tab portal toolbar homepage will allow users to choose and navigate from at least 5 different selections. The first selection is for users to sign up and download our tab portal toolbar. Users will come to our website and see the different functionalities and possibilities of our tab portal toolbar. Users will be able to see a demo of how they can customize their own tab portal toolbar, share their tab portal toolbar with others, add other users' toolbars for their own use, and communicate with other users in our tab portal toolbar community. Once users decide to sign up for our tab portal toolbar, there will be a download button.

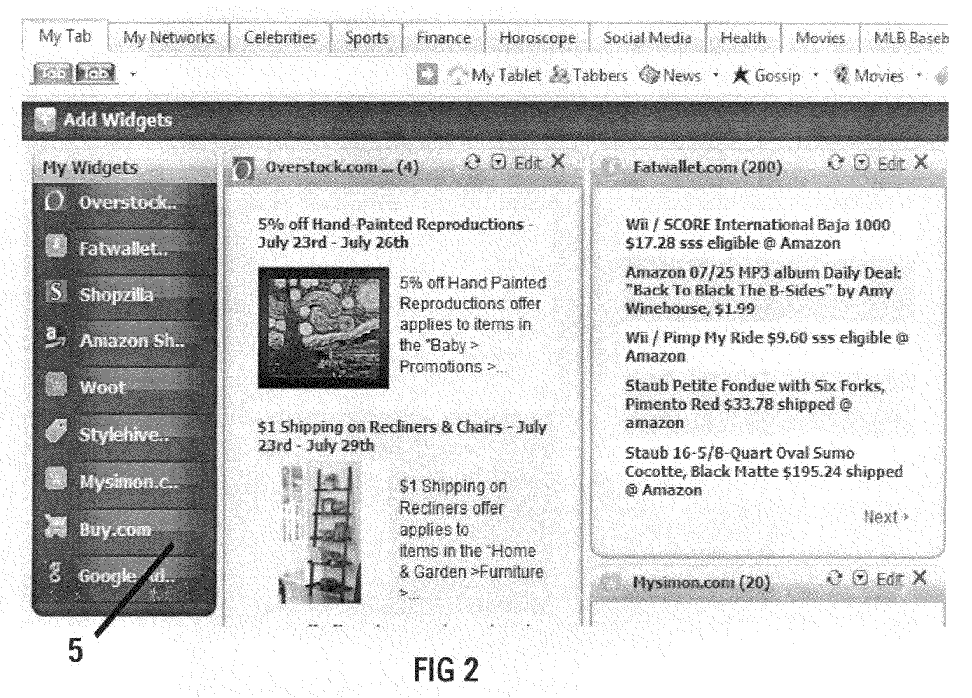

As shown in FIG. 2, the preferred user selection of content for personalized toolbars. There will be at least two methods users will be prompted to our download page. One is when they click the Join Tab portal toolbar button from our Homepage. Second is when first time users browse through our website and see a tab portal toolbar or tablet they are interested in and click the add Tab portal toolbar button. Either method will prompt them to a sign up page which they will be required to fill out their personal info—name, birthday, location, email, and toolbars they are interested in having on their Tab portal toolbar. Once user identification process is complete users will be able to download our tab portal toolbar. If the users came from clicking the add Tab portal toolbar button, then that tab portal toolbar or tablet will automatically be added to their Tab portal toolbar tab portal toolbar when the download process is finished.

Once the download is complete, a screen will appear which introduces said users to their default tab portal toolbar, the other toolbars they have selected, and the functions in their tab portal toolbar. They will also be shown that they have successfully downloaded their tab portal toolbar and only a few short steps from using the most customizable tab portal toolbar available on the internet.

In the profile page, users will be shown how they can customize their profile. They can either go through with the demo or skip. Next, users will be prompted to the last step which leads them to a page that shows a demo on how they can start customizing their toolbars. This demo will elaborate a little bit more on tablets 15 (Ref. Tablet page) and the applications and features they can add to their tab portal toolbar—allowing them to either skip that page and start using their tab portal toolbar. They can either skip this demo or press finish which ends their sign up process.

The other way a user will be prompted to our download page is simply to click on sign up on our homepage. The same steps will apply as above. Once users have downloaded the tab portal toolbar and start using it, every tablet that they click on will have a demo on that particular tablet or tab.

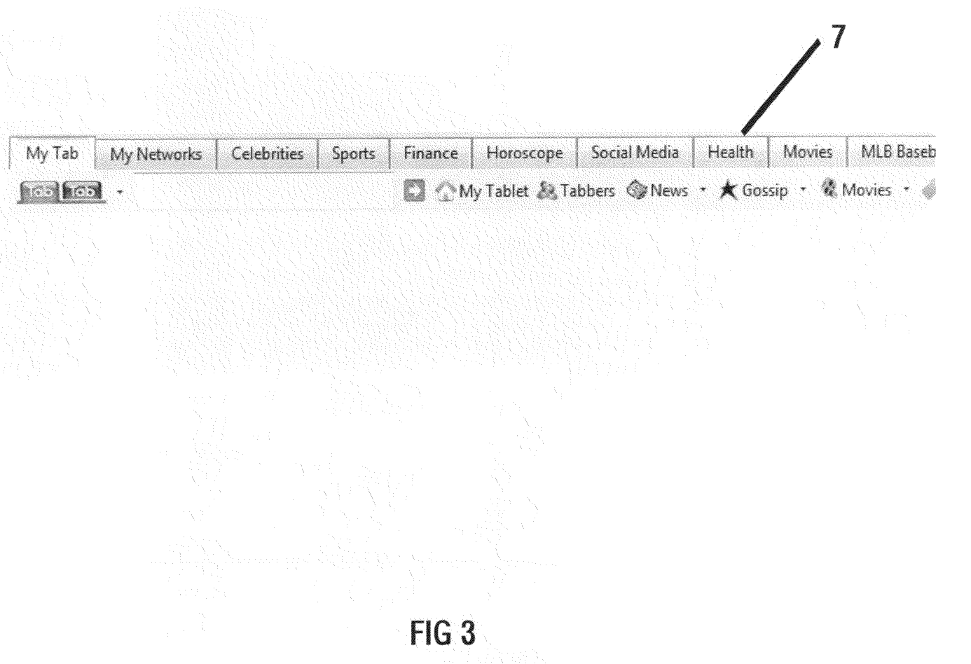

As shown in FIG. 3, the preferred method for users to customize their toolbars. The second selection is for users to search, browse, and add toolbars as well as see other users that have the same tab portal toolbar. On BarTabs, bars page, users will be able to search by category, enter a search term in our search area, or search by tags for the tab portal toolbar that they might want to add. Ex: if they are into sports, they can browse under sports and see all the different toolbars created for that category. Users will also see a list of the most popular and most recently added toolbars. Users will also see a preview of the different toolbars which contains a title, description, tags, who created the tab portal toolbar, when it was last updated, how many times it has been added as well as comments and ratings of the tab portal toolbar. The bar page also displays all the tabbers that have a particular tab portal toolbar. Ex: If someone searches for a sports tab portal toolbar, it will display a list of all the tabbers that own a sports bar. Once users click on the preview for a particular tab portal toolbar, it will open another page that gives more details of that specific tab portal toolbar.

Once a user arrives at BarTabs toolbars page; they will see a list of most popular toolbars. In the preferred embodiment, users will see a list of toolbars by categories, tags, and most recently added. Once category is selected, the category will collapse into subcategories that list all the toolbars in that subcategory. The page will also display a preview of the tab portal toolbar in the main category as well as a preview of the toolbars in the subcategory. Ex. Users click on the main category sports, it will collapse into all subcategories for sports such as basketball, football, baseball, hockey, golf, soccer, tennis, motor racing, cycling and other sports. The page will display a preview of the sports tab portal toolbar and all the subcategory toolbars such as basketball, football, baseball, soccer, golf, and so forth. The Tab portal toolbar tab portal toolbar comprise at least five parts; the options menu, the tablets 15 on the tab portal toolbar which are the main features of the tab portal toolbar, the tabs 1 on the tab portal toolbar which are the other toolbars broken down into tabs 1, an add bar button, and a search function. The option menu allow for users to adjust any settings on their tab portal toolbar and customize the colors of their tablets 15 and toolbars. The option menu also contains a function for sign in/out, an about us, and settings. Tablets 15 are buttons which launch applications such as bookmarks, feeds for photos, videos, news, sports, comics, stocks, and alerts 9. Tablets 15 can also launch other interactive applications such as calendars, weather, calculator, maps, music players, and many more. The tabs 1 on the tab portal toolbar are other toolbars a user has added on their browser. New tabs 1 are created once a user adds any additional tab portal toolbar to their browser. The default tab would be called MyBar which is their default tab portal toolbar. Once a user clicks on a different tab on their tab portal toolbar, the tablets 15 will change accordingly to the new tab portal toolbar chosen. The add bar button allows users to add an additional tab portal toolbar on their browser. The search function on the tab portal toolbar is powered by google and allows users to search anything they want. The results would be the search results from google. There is a drop down menu next to the search box that allows users to choose the type of content they are searching for: image, videos, news, blogs, or local. Here is a list of the different tablets 15 that would be on the default tab portal toolbar once a user downloads it. Users then can add the tab portal toolbar they want by clicking on the add button icon on the preview of the tab portal toolbar.

The tabs 1 on the tab portal toolbar are other toolbars a user has added on their browser. New tabs 1 are created once a user adds any additional tab portal toolbar to their browser. Once a user clicks on a tab the tab portal toolbar will update to that tab as well as all the tablets 15 on the tab portal toolbar. From there users can use the tablets 15 on the tab portal toolbar they have chosen. Users can click a button on their tab which will allow users to share, edit or delete the tab.

Once they click add, the tab portal toolbar will be added on their browser. The user also has the option of clicking on the preview of the tab portal toolbar for more information. Once they do this, a new page will open where users would be able to see all the details of that tab portal toolbar. The page will show the tab portal toolbar and all the tablets 15 in that tab portal toolbar. On this page there will be two tabs 1: one will be called Mytab and the other will be called All. Under the Mytab tab, there is a list of all the tablets 15 that were originally created for the tab portal toolbar. Then under the All tab, there will be a list of all the tablets 15 for that tab portal toolbar that have been added by other users since it was first created. Once they click add, the tab portal toolbar will be added on their browser. Then they can choose to add additional tablets 15 that are available for the tab portal toolbar they just added. Users will also be able to click on other users on the tab portal toolbar page since the site will show the users that have the same toolbars as them and this will lead them to the user's profile page. Through the users profile page, they can see the different toolbars and tablets 15 they have and can add their toolbars and tablets 15.

The add bar button on the tab portal toolbar will direct user's to our tab portal toolbar page where users can select from a list of popular toolbars, a list of categories, or search for a specific tab portal toolbar they are looking for. Once they have found the tab portal toolbar they want, they can easily add it by the click of a button. Then a new tab would be automatically created with the new tab portal toolbar they added.

When a user decides to add a tab portal toolbar, they can add a tab portal toolbar from a list of existing toolbars or they can customize their own tab portal toolbar. If a user decides to customize their own tab portal toolbar, they will be prompted to add a title, description, and tags for their tab portal toolbar. From there, users will be offered a list of suggested tablets 15 that can be added based on the keywords they tagged their tab portal toolbar with. If they choose not to add any of the suggested tablets 15, they can search for other tablets 15. Another option would be for the user to create personalized tablets 15 which can be added to their tab portal toolbar. Once users have finished customizing their new tab portal toolbar, they will have the option of sharing it to others or making it for personal use.

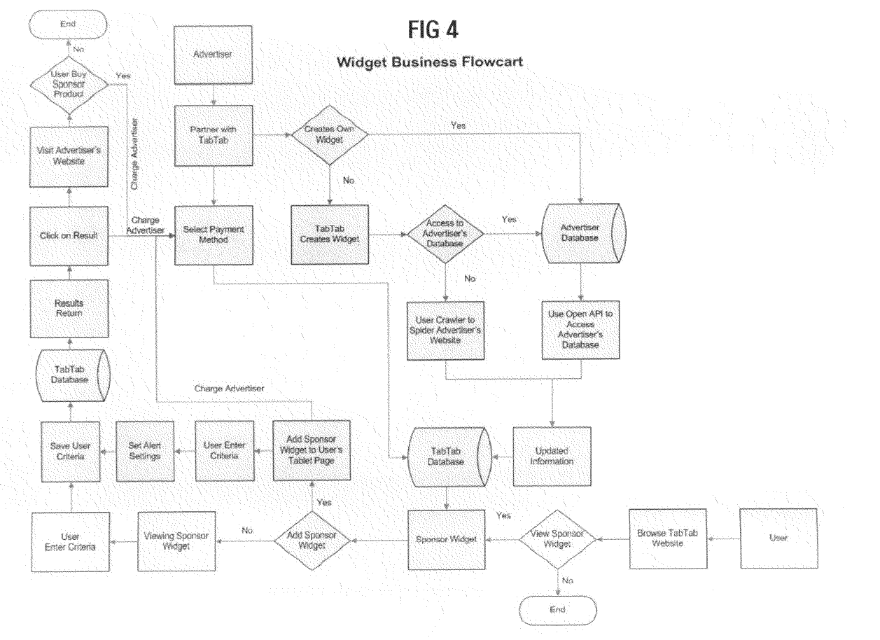

As shown in FIG. 4, the preferred method of customizing tablets 15. Tablets 15 are buttons which launch applications such as bookmarks, feeds for photos, videos, news, sports, comics, stocks, and alerts 9 to name a few. Tablets 15 can also launch other interactive applications such as calendars, weather, calculator, radio, maps, music players and games. Tablets 15 can include feeds, podcasts, apps, menus and allow users to customize them according to their needs. Once a user clicks any tablet on their tab portal toolbar, a new page will drop down. The drop down page would contain all the content or applications a user has in their tablet. Users can also add more content to their tablets 15 from the drop down page. There would also be a settings feature where users can edit the privacy of their tablet allowing only for private use, sharing it with friends only, or sharing it with the tab portal toolbar community. In the settings feature, users can also edit or delete tablet, change the title, description, tags, layout, colors and display. The page would also show all the tabbers that have the same tablet, enabling them to interact with each other and potentially share other useful content.

Users may search, browse, and add tablets 15 as well as see other users that have the same tablets 15. Tablets 15 are buttons which launch applications such as bookmarks, feeds for photos, videos, news, sports, comics, stocks, and alerts 9.

In an alternative embodiment, tablets 15 can also launch other interactive applications such as calendars, weather, calculator, radio, maps, music players, and many other uses. Tablets 15 can include feeds, modules, and allow users to customize the tablet according to their needs. On our tablets 15 page, users will be able to search by category or tags for the tablet that they might want to add. Ex: If they are interested in sports, they can browse under sports and see all the different tablets 15 created for that category. Users can also see a list of the most popular, most recent, and the most tagged tablets 15. Users can also see a preview of tablets 15 which contains a title, description, tags, who created the tablet, when it was last updated, how many times it has been added as well as comments and ratings of the tablet. Users would also be able to choose the type of tablet that they are looking for—whether they are feeds, apps, tablets 15 which can contain both feeds and apps in them, or menus which can contain multiple tablets 15. The tablet page also displays all the tabbers that have a particular tablet. Ex: If someone searches for a sports tablet, it will display a list of all the tabbers that own a sports tablet. Once users click on the preview for a particular tablet, it will open another page that gives more details of that specific tablet. The tablet page will also allow developers and users to create new tablets 15 from our API section.

Once a user arrives at the MyTab tablets 15 page; they will see a list of our most popular tablets 15. They will also see a list of tablets 15 by categories, tags, and most recently added. Once a user clicks on a category, the category will collapse into subcategories that list all the tablets 15 in that subcategory. The page will also display a preview of the tablet in the main category as well as a preview of the tablets 15 in the subcategory. Ex. Users click on the main category sports, it will collapse into all subcategories for sports such as basketball, football, baseball, hockey, golf, soccer, tennis, motor racing, cycling and other sports. The page will display a preview of all the tablets 15 in that category such as basketball, football, baseball, soccer, golf, and so forth.

Users then can add the tablet they want by clicking on the add button icon on the preview of the tablet. Once they click add, the tablet will be added on their tab portal toolbar. The user also has the option of clicking on the preview of the tablet for more information. Once they do this, a new page will open where users would be able to see all the details of that tablet. On this page there will be two tabs 1: one will be called Mytab and the other will be called All. Under the Mytab tab, there is a list of all the contents that were originally created for the tablet. Then under the All tab, there will be a list of all the different content for that tablet that have been added by other users since it was first created. Once they click add, the tablet will be added to their tab portal toolbar. Then they can choose to add additional content for the tablet they just added such as feeds or apps. Users will also be able to click on other users on the tablet page since the site will show the users that have the same tablets 15 as them and this will lead them to the user's profile page. Through the users profile page, they can see the different toolbars and tablets 15 they have and can add their toolbars and tablets 15.

When a user decides to add a tablet, they can add a tablet from a list of existing tablets 15 or they can customize their own tablet. The existing list of tablets 15 that would be available includes tablet, feeds, apps, or menus. Users can then choose the different types of tablet they would like to add to their tab portal toolbar. Ex: if they choose to add a feed tablet, they will only be shown tablets 15 that perform feed functions such as a scores feeds or stats feeds. If they choose an apps tablet, they will be shown a list of apps tablet such as games, maps, currency exchanger, and so forth. If a user decides to create their own tablet, they will be prompted to add a title, description, and tags for their tablet. Then a user must choose the type of tablet they want to create. There choices would be: feed template, apps template which will bring them to our developers API section, or menu template. From there, users will be offered a list of suggested content that can be added based on the keywords they tagged their tablet with. If they choose not to add any of the suggested content, they can search for other content. A person that decides to create a feed tablet would be offered a suggested list of feeds to add to that template. However they can enter their own feed url on our feed tablet template and add as many feeds as they want. Once they're done with the feeds, they can click finish and now have their own customized tablet. Once users have finished customizing their new tablet, they will have the option of sharing it to others or making it only for personal use.

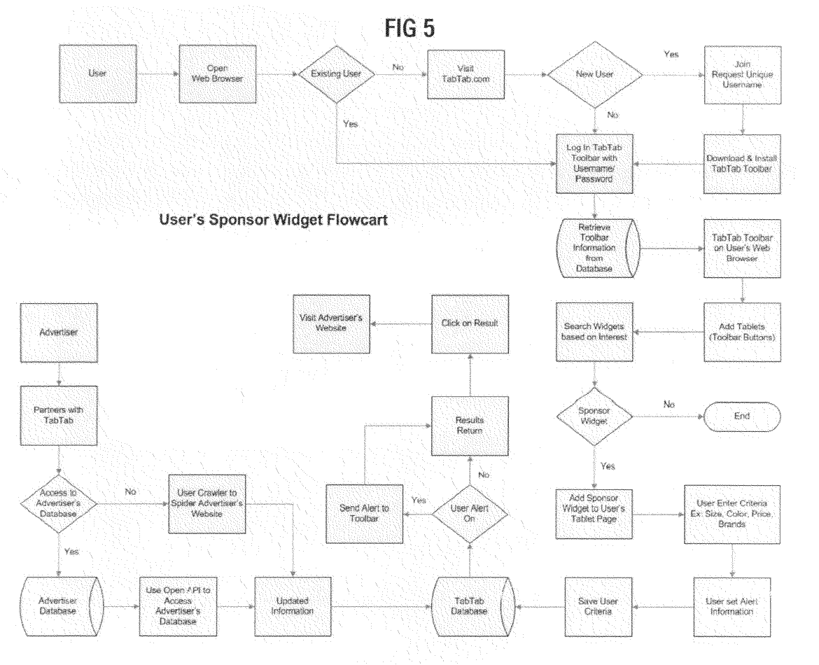

As shown in FIG. 5, the preferred embodiment of the method to customize the tabbers. Tabbers are users who have downloaded our Tab portal toolbar tab portal toolbar. Each tabber would be assigned their own website and inbox. Each tabber would be able to personalize and customize their tab portal toolbar according to their needs. Tabbers will also have a profile that they can customize to their level of content. Tabbers can add photos, videos, bookmarks, blogs, instant messaging, to do lists, bulletin board, games, and many other unique features on their profile. Each tabber has the option of setting different privacy options which can set their toolbars, tablets 15, and profile to private, allowing no one to see any of their content. They can also set it so that only they're friends have access to their content or they may make it available for all users to see. The same privacy options would be considered when other users are trying to contact each other. We aim to build a tab portal toolbar community where tabbers can easily communicate and share with each their content, but also respect each tabber's preference to keep their content private. We aim to be able to provide a platform where tabbers can easily send each other messages, videos, photos, games, bookmarks of sites they find interesting, and whatever they would like to share. We want tabbers to be able to discover, meet, network, connect, learn, help, share, and give to other tabbers within our unique tab portal toolbar community.

The tabbers page contains all users and contains a search function that one can search by location, age, gender, interest, or other tabbers that have the same toolbars or tablets 15. The tabbers page also lists tabbers by most popular, most recent, last login, and most active. The tabbers page also displays a list of popular groups where users can join, add photos, videos, music, blogs, forums, share and discuss matters they have in common.

Once a user arrives at our the tabbers page, they will have the option to search for tabbers based on their preference such as age, gender, location, interest and so forth. The search result will bring about the tabbers within their query. Users can also see a list of the most popular, recently joined, or most active tabbers. Once a user clicks on a tabber they find interesting, they can explore their page and if they find that tabber interesting, they can contact them or request to add them as a friend. Users can also join groups by clicking on the groups they are interested in. Once they click on groups, they will see all the tabbers in that group and what the group is about and join that group.

### From Tab Portal Toolbar—User Actor

1. Tab portal toolbar Tab portal toolbar having a Tablet+AddBar if user clicked on that it will display a Slider window with the options like Add to Videos, Add to Feeds, . . . and Add to Site Tracker, from this option user can add URLs or Some content on the web page to Site Tracker for monitoring.
2. We need to provide some interface to user from where he can manage there Web pages information, given below.
   a. Displaying all Added URLs/Content
      i. It needs to display last Crawled time stamp also
   b. Adding new Web Page URL
   c. Editing existing Web Pages URL
   d. Removing existing URL(s)
   e. Setting Frequency each URL (if user want then only, other wise it is set to Default frequency which is set by Site Tracker Admin), user can set minimum 3 Hr or more frequency.
3. If any change exist in user added Content/URL from tab portal toolbar it will display a slider window with in it Highlighting the changed content, if user clicked on the slider window it will display the same page (actual URL) in Browser with changed content highlighting.

### From Site Tracker Admin—Admin Actor

1. URL Limit: Every user having there own limit value for adding number of Web pages to site tracker for now it is fixed to 100, for all users initially this value is set to default value which is set from the Site Tracker Admin panel by Site Tracker Admin . . . .
2. Even Site tracker Admin can set the URLs adding limit to particular user(s). Ex:—Like I want to allow my corporate people to 200 URLs/Contents.
3. Crawler Frequency: Site Tracker Admin can set the Crawler(s) Default Crawling frequency value from Control panel by default this value will be applicable for all Crawler . . . .
4. Even Site Tracker Admin can set Frequency value for selected Crawler.
5. Managing Number of Crawlers: Site Tracker Admin can add Crawlers and can set the Crawler details from Admin panel. Like . . .
   a. Crawler1—visit sites 1 to 1000 with default frequency 1 Day . . .
   b. Crawler2—visit sites 1001 to 1500 with default frequency 2 Days . . .
6. And Admin should be able to manage the Crawlers information Adding/removing/modifying frequency.

### Architecture:

1. Site Tracker Web Server will be a dedicated server, which will serve all site tracker information to Tab portal toolbar, users.
2. Site Tracker Database server will be a dedicated server with high bandwidth capacity, it contain all the information about Site Tracker system.
3. Site Tracker Crawler Server this will be a dedicated server with high bandwidth capacity, it always depend upon the Site Tracker Database for getting frequency, Sites information, . . . and after Crawling Site Tracker Crawler Server will keep information in Site Tracker Database.
4. And the Site Tracker Deployment may contain more than one Site Tracker Crawler Server and it can be added at any time with out disturbing the existing system and those servers can be located in any location.
5. Site Tracker Crawling Logic may improve at any time with out affecting the existing system.
6. Site Tracker Crawling Frequency logic may improve at any time with out effecting existing system.
7. All servers are located at remote places.

### Basic Layout of TabTab:

User can add multiple tabs 1 on a TabTab toolbar. User can a number of tablets 15 on each tab. User can add different widgets 17 to each tablet.

What Are Tabs 11?
Toolbar 7 tabs 1 allow you to view, organize, and access multiple toolbars 7 on one toolbar 7 without sacrificing any space on your browser. Easily create, add and share toolbar 7 tabs 1 with friends across our platform.

What Are Tablets 15?
Tablets 15 are custom interactive buttons on the toolbar that can perform a wide variety of functions such as: act as a quick link to websites you frequent, open up a page which allows for organizing information such as feeds, widgets 17, or URLs, open a standalone window that can display your favorite widget such as a music player or weather widget and much more. Tablets 15 can also be shared with the TabTab community.

What are widgets 17?
A web widget is a mini-web application that you can put in your web page, blog or social profile that can quickly and easily provide you with specific information, extra functionality, and anything from simple profiles to full-blown applications. Widgets 17 can come in the form of photos, videos, feeds, news, weather information, games, calendars, calculators and much more.

How is the Search Different from Other Toolbars?
Our search feature offers the unique ability to aggregate and display different search engines in the form of widgets 17 on one page. This way you can see the most relevant results from multiple search engines at once. Also you can combine and customize different search engines such as a Google Image search with an Yahoo web search and a Youtube video search into one place with “My Search”.

What is WebCip Widget?
WebClip Widget allows you to clip any part of a website and put it into a widget. This allows you to take any part of your favorite website and turn it into a widget. With the Webclip widget, you also have the option to track any changes on the clipped content and get alerted on your toolbar.

### Summary to Reproduce the TabTab Toolbar:

Basically for someone to build a dynamic toolbar like ours they just need a database in the backend and build a plugin toolbar for a web browser like Internet Explorer or Firefox and have the toolbar read a dynamic file like an XML file.

### Installation Process & Files Needed to be Install on the User's Computer:

1. When a user join they'll download a setup executable TabTab.exe
2. User install TabTab onto their computer
3. The following files get install onto their computer (default directory is c:/program files/tabtab):
*XML folder includes a TabTabToolbar.xml file for Internet Explorer and FFTabTabToolbar.xml for FireFox and TabTabBasic.xml when user is not sign in.
Image folder which stores the default icons for the toolbar
Following DLL gets install TabTab.dll & TTBHO.dll
TabTabUpdate.exe (alert user when there's a new update of the TabTab software)
FFTabTab.xpi (for Firefox plugin extension)

*The TabTabToolbar.xml is the most important file. This file controls what goes onto the Toolbar. It's pretty much the TabTab configuration file. When a user log into the TabTab toolbar the TabTabToolbar.xml (or FFTabTabToolbar.xml if they are using FireFox) will get populated with the details of what the TabTab toolbar will include like what Tabs 1, Tablets 15 and Tablet menu will show up on the toolbar. It determines what the user will see and how each button will function.

Adding Content after Installing TabTab:

After the user install TabTab everything else is pretty much done in the database backend. There's no additional downloading required.

For example:

1. New user sign up they get added into the User table in the database.
2. When a user add a new tab to their toolbar a record gets added into the Tab table in the database.
3. When a user add a new tablet to their toolbar a record gets added into the Tablet table in the database.
4. When a user add a new widget to their tablet page a record gets added into the Widget table in the database.

Therefore, a user can go to the TabTab website and they could go to another user's toolbar or Add Tabs 1, Add Tablets 15, or Add Widgets page and click the Add button to add content to their toolbar. Nothing else gets downloaded except for when they add a new icon to their toolbar then it'll get downloaded into the image folder. The only file that gets updated is the TabTabToolbar.xml. This file makes the TabTab toolbar dynamic as new updates and alerts 9 are pass through this file.

### Table Structure:

There are many tables in the database but the four major tables are:

### User Table

### UserID

### Name

User Info columns

### Tab Table

### TabID

### UserID

### Tab Name

Tab Details like Name, Description, Privacy, etc. . . .

### Tablet Table

### TabletID

### TabID

### Tablet Name

Tablet Details like Name, Description, Icon, Privacy, etc. . . .

### Widget Table

### WidgetID

### TabletID

### Widget Name

Widget Details like Name, Description, Icon, Links, Source Code, etc. . . .

All four of these tables and more then interact with each other to determine what kind of toolbar the user have like what tabs 1 are in the toolbar and what tablets are in each tab and what tablet includes what widgets. When a user sign in the TabTabToolbar.xml will then get updated this new configuration and the browser toolbar will then reflect this information.

User can Drag and Drop Files, Folders and URL Links onto TabTab Toolbar. An URL tablet or a Shortcut tablet is then added to the TabTab toolbar along with the website or the application icon.

1. Drag & Drop Webpage URL onto TabTab
a. User opens up a web browser and go to a webpage.
b. User drag the url or the webpage icon onto the TabTab toolbar. Website title, tooltip (domain name), and url dialog box popups where user can edit before saving.
c. URL Tablet gets created along with the website icon (favicon).
d. When url tablet(button) is clicked it'll open to that webpage.
2. Drag & Drop Application or Files onto TabTab
a. User can drag the application from desktop, program files, or window explorer.
b. User drop the application onto the TabTab toolbar.
c. Shortcut tablet gets created along with application icon and shortcut to the application. Title, tooltip, and shortcut dialog box popups where user can edit before saving.
d. When shortcut tablet is clicked it'll launch that application.
3. Drag & Drop Folders onto TabTab
a. User can drag a folder from desktop or window explorer.
b. User drop the folder onto the TabTab toolbar.
c. Shortcut tablet gets created along with a folder icon and shortcut to the folder Title, tooltip, and shortcut dialog box popups where user can edit before saving.
d. When shortcut tablet is clicked it'll open up the folder.

While the above invention has been described with reference to certain preferred embodiments, the scope of the present invention is not limited to these embodiments. One skilled in the art may find variations of these preferred embodiments which, nevertheless, fall within the spirit of the present invention, whose scope is defined by the claims set forth below.

We claim:

1. In a computer web system, a method of streamlining internet surfing and e-commerce through the use of a tab system wherein all steps are performed by a computer system, the method comprising:
a. Registering by a user for the tab system;
b. downloading software onto user's internet device or computer;
c. Selecting at least one tab categories which have been pre-generated by the tab system;
d. Revealing a toolbar associated with said tab with a tab bar with all types of information related to the tab category;
e. Creating by a user a new tab category or a personalized version of said category;
f. Populating said tab category with tablets, buttons, widgets, feeds, and website snippets;
g. Allowing users to isolate areas of interest from third party websites;
h. Cutting said area of interest and pasting into a tab bar as a website snippet;
i. Determining by the tab system of updates by said third party site;
j. Notifying said user of website updates thus to prevent said user from needlessly visiting every website individually for updates;
k. Updating said tab snippet accordingly;
l. Allowing users to copy third party widgets or tab system widgets into their tab category bar;
m. Allowing users to perform web search through the tab systems which in turn simultaneously searches a predefined set of search engines;
n. Displaying to said users targeted advertising based upon user tab categories and searches.

2. A method as in claim 1, wherein a history of prior snippets are logged.

3. A method as in claim 1, wherein directed advertising stem from information from merchants, web crawlers, tab system database, and other shopping search engines.

4. A method as in claim 1, wherein notifications may alert users of recent website updates, snippet updates, and feeds.

5. A method as in claim 1, wherein notifications maybe located on various taskbars and toolbars.

6. A method as in claim 1, wherein category tabs of users may be made visible to other users.

7. A method as in claim 1, wherein category tabs may be shared or copied by other users.

8. A method as in claim 1, wherein third party widgets allows up to date information, specials, offers, and deals to users whom decide to add said third party widget to their tool bar.

9. In a computer web system, a method of streamlining internet surfing and e-commerce with directed advertising through the use of at least one customized category web portal/tab wherein all steps are performed by a computer system, the method comprising the steps of:
a. Allowing users to install and setup an software, producing at least one customizable discrete web portal with a multiplicity of category tab bars on a window;
b. Administrating said applets through at least one centralized server and at least one centralized database;
c. Segregating and defining preferences of tab content such as widgets as wells as category based on user preference for each individual tab;
d. Filling said tabs by users with portions of websites of interest through widgets which fit into their particular preference;
e. Allowing users to distinctly define the contents as well as to enable topics to be further categorized into subgroups within said tab;
f. Updating information within said tabs with new information which is updated on the corresponding website;
g. Allowing the user to easily identify and locate new information without visiting each individual website;
h. Enabling users to create customized internet commerce searches based upon criteria such as item description, price, color, and size with in widget;
i. Facilitating internet commerce by allowing customers to locate their desired deals based upon said user specified criteria to a specific widget; and
j. Saving demographic information on users, user interest, and user searches within said centralized database.

10. In a computer web system, a method of streamlining internet surfing and e-commerce with directed advertising through the use of a customized web portals/tabs wherein all steps are performed by the computer system, the method comprising the steps of: comprising:
a. Allowing users to install and setup an applet, producing customizable discrete web portal with a multiplicity of category tab bars on a window;
b. Administrating said applets through at least one centralized server and at least one centralized database;
c. Segregating and defining preferences of tab content such as widgets as wells as category based on user preference for each individual tab;
d. Filling said tabs by users with portions of websites of interest through widgets which fit into their particular preference;
e. Allowing users to distinctly define the contents as well as to enable topics to be further categorized into subgroups within said tab;
f. Updating information within said tabs with new information which is updated on the corresponding website;
g. Allowing the user to easily identify and locate new information without visiting each individual website;
h. Enabling users to create customized internet commerce searches based upon criteria such as item description, price, color, and size with in the particular tab group;
i. Facilitating internet commerce by allowing customers to locate their desired deals based upon said user specified criteria to a specific widget;
j. Saving demographic information on users, user interest, and user searches within said centralized database; and
k. Charging merchants a transaction fee based upon commerce through said system by users.

11. A method as in claim 10 wherein said fees are based upon web traffic to the entities' site.

12. A method as in claim 10 wherein said fees are based upon spider hits onto said entities' site.

13. A method as in claim 10 wherein said fees are based upon a subscription basis.

14. A method as in claim 10 wherein said fees are based upon percentage of actual sales transacted.

15. A method as in claim 10 wherein said fees are based upon a cost per defined number of impressions.

16. A method as in claim 10 wherein said fees are based upon a predetermined referral fee.

17. A method as in claim 10 wherein said fees are based upon the number of merchant widgets added.

18. A method as in claim 10 wherein said directed offers to users maybe due to an interest by an entity to reduce inventory.

19. A method as in claim 10 wherein said directed offers to users included merchandise which are samples, first offerings, limited editions, market tests, pre-orders, exclusive, discontinued, refurbished, returned, open packages, or from a prior seasons.

20. A method as in claim 10 wherein said user searches may be executed by spiders for user parameters such as but are not limited to: country, price, condition, color, size, style, and auction.

21. A method as in claim 10 wherein said searching is performed by spiders.

22. A method as in claim 10 wherein merchants send offers directly to user whom had interest in such a product/services or have had interest in related products/services for a fee.

23. A method as in claim 10 wherein merchants to send offers directly to at least one remote data center to redistribute said offers to all users whom had interest in such a product/services or have had interest in related products/services for a fee without the entity having information on the users identity prior to purchase.

24. A method as in claim 10 wherein merchants are provided spider search information, user demographic, and user interest information to entities such as merchants, retailers, and wholesalers for a fee.

25. A method as in claim 10 wherein alerts may be made to the user based upon tab updates or search results stemming from a product or service desired.

26. A method as in claim 10 wherein alerts may be in the form of a toolbar alerts, text message, email, or automated phone message.

27. A method as in claim 10 wherein users can dissect websites based upon user interest.

28. A method as in claim 27 wherein said snippets or dissected portions are updated on a predetermined continual basis.

29. A method as in claim 28 wherein upon a user clicking on a topic tab, all relevant and current information is displayed from a multiplicity of websites accumulated by the user.

30. A method as in claim 29 wherein entire tabs can be shared with other users if desired.

31. A method as in claim 30 wherein using users' tab content to facilitate networking amongst users with similar interests.

32. A method of streamlining internet surfing and e-commerce with directed advertising through the use of a customized web portals through tabs comprising:
a. Allowing users to setup a customizable discrete web portal based upon category via tab bars on a window;
b. Segregating tabs groups based on user preference for each portal;
c. Filling said tabs by users with websites of interest through widgets which fit into their particular preference;
d. Allowing users to distinctly define the contents as well as to enable topics to be further categorized into subgroups within said tab;
e. Updating information within said tabs with only the new information which is updated on the corresponding website;
f. Allowing the user to easily identify and locate new information without visiting each website within said group;
g. Enabling users to create customized internet commerce searches based upon criteria such as item description, price, color, and size with in the particular tab group;
h. Facilitating internet commerce by allowing customers to locate their desired deals based upon said user specified criteria to a specific widget;
i. Saving demographic information on users, user interest, and user searches;
j. Allowing merchants to submit sales offers and information to a centralized server for analysis; and
k. Sending said sales information to users based upon their user information showing some interests in said information.

33. A method for customizable web portal to enhance and expedite internet surfing comprising:
a. Utilizing a multiplicity of tabs within a browser window to designate and segregate user interests or topics;
b. Selecting a multiplicity of websites to be grouped within the same tab category;
c. Dissecting said websites for particular content locations of interest;
d. Pasting website clippings within a particular tab category;
e. Predetermining set times for said portal to seek updated content from said individual websites;
f. Updating snippets of clippings from the individual websites to keep the user appraised of updates without the need for the user to access each individual site;
g. Selecting by the user of an interest tab allows the user to view the most recent information on all selected sites wherein snippets were taken; and
h. Recording user interest information based on tabs and tab content to facilitate a directed marketing campaign wherein merchants can target offers to users whom have interests or need for their products.

34. In a computer web system, a method of streamlining internet surfing and e-commerce with directed advertising through the use of a customized web portals/tabs wherein all steps are performed by the computer system, the method comprising the steps of: comprising:
a. Allowing users to install and setup an applet, producing customizable discrete web portal with a multiplicity of category tab bars on a window;
b. Administrating said applets through at least one centralized server and at least one centralized database;
c. Segregating and defining preferences of tab content such as widgets as wells as a category based on user preferences for each individual tab;
d. Filling said tabs by users with portions of websites of interest through widgets which fit into their particular preference;
e. Allowing users to distinctly define the contents as well as to enable topics to be further categorized into subgroups within said tab;
f. Updating information within said tabs with new information which is updated on the corresponding website;
g. Notifying users of updates on said user tool bar of any updates to corresponding websites such as RSS feeds, widget updates, website updates, updated sales prices, and sales offers;
h. Allowing the user to easily identify and locate new information without visiting each individual website;
i. Enabling users to create customized internet commerce searches based upon criteria such as item description, price, color, and size;
j. Facilitating internet commerce by allowing customers to locate their desired deals based upon said user specified criteria to a specific widget;
k. Saving demographic information on users, user interest, and user searches within said centralized database; and
l. Charging merchants a transaction fee based upon commerce through said system by users.

35. In a computer web system, a method of streamlining internet surfing and e-commerce through the use of a tab system wherein all steps are performed by a computer system, the method comprising:
a. Registering by a user for the tab system;
b. downloading software onto user's internet device or computer;
c. Selecting at least one tab categories which have been pre-generated by the tab system;
d. Revealing a toolbar associated with said tab with a tab bar with all types of information related to the tab category;
e. Creating by a user a new tab category or a personalized version of said category;
f. Populating said tab category with tablets, buttons, widgets, feeds, and website snippets;
g. Allowing users to isolate areas of interest from third party websites;
h. Cutting said area of interest and pasting into a tab bar as a website snippet;
i. Determining by the tab system of updates by said third party site;
j. Notifying said user of website updates thus to prevent said user from needlessly visiting every website individually for updates;
k. Updating said tab snippet accordingly;
l. Allowing users to copy third party widgets or tab system widgets into their tab category bar;
m. Allowing users to perform tab searches through the tab systems which in turn simultaneously searches a predefined set of search engines;
n. Displaying to said users targeted advertising based upon user tab categories and searches;
o. Allowing users to add tablet buttons to open various software applications; and
p. Allowing users to add tablet buttons to access frequently used file directories.

36. A system for organizing internet content and update alerts to streamline user interaction with the internet along with advertisements comprising:
a. a client web browser configured to render a tab window having a designated location for a multiplicity of category tabs containing various internet content wherein said tab window enables user interactions and submission of user interaction data via a submit function, and be rendered;
b. an advertisement database configured to store a plurality of self-contained advertisements based upon product or service specifications;
c. a widget database configured to store a plurality of self-contained widgets based upon category or user specifications;
d. a snippet database configured to store a plurality of self-contained snippets based upon category or user specifications;
e. an advertisement server element communicatively connected to the client web browser and the advertisement unit database element, the advertisement server element configured to, receive the user interaction data, dynamically process the user interaction data to select a self-contained advertisement unit from the plurality of self-contained advertisements stored in the advertisement database element, and send a self-contained advertisement to the client web browser; and an application server element communicatively connected to the client web browser and widget database element and snippet database element, the application server element configured to, receive the user interaction data, dynamically process the user interaction data to display and update widgets and web snippets, further to provide real time notification to the user for any updates.
